(19) United States
(12) Patent Application Publication
(10) Pub. No.: US 2025/0165197 A1
(43) Pub. Date: May 22, 2025

(54) NON-TRANSITORY COMPUTER-READABLE STORAGE MEDIUM STORING PROGRAM, INFORMATION PROCESSING APPARATUS, AND CONTROL METHOD

(71) Applicant: CANON KABUSHIKI KAISHA, Tokyo (JP)

(72) Inventor: TOMOYA KOBAYAKAWA, Kanagawa (JP)

(21) Appl. No.: 18/942,846

(22) Filed: Nov. 11, 2024

(30) Foreign Application Priority Data
Nov. 21, 2023 (JP) 2023-197591

(51) Int. Cl. G06F 3/12

(52) U.S. Cl. CPC G06F 3/1236; G06F 3/1209; G06F 3/1294; G06F 3/1292

(57) ABSTRACT

A non-transitory computer-readable storage medium storing a program configured to cause a computer to function as: a confirmation unit configured to confirm a communication state between an information processing apparatus and an external apparatus via a predetermined relay apparatus; and a control unit configured to execute control based on a fact that the confirmed communication state is a predetermined state so that a frequency band used in connection between the information processing apparatus and the predetermined relay apparatus is changed from a first frequency band to a second frequency band different from the first frequency band.

### BACKGROUND OF THE INVENTION

### Field of the Invention

The present invention relates to a non-transitory computer-readable storage medium storing a program, an information processing apparatus, and a control method.

### Description of the Related Art

There is provided a technique in which an information processing apparatus and an external apparatus communicate with each other via a Local Area Network (LAN) connected to the Internet. ALAN is sometimes constituted by a wireless network. In this case, the installation place of a device can be freely selected, as compared with a wired network. Japanese Patent Laid-Open No. 2018-191252 describes a method of connecting, by using an information processing apparatus, an external apparatus to a network formed by an access point.

### SUMMARY OF THE INVENTION

The present invention provides a non-transitory computer-readable storage medium storing a program for improving convenience in a case where it is impossible to execute communication with an external apparatus via a relay apparatus, an information processing apparatus, and a control method.

The present invention in one aspect provides a non-transitory computer-readable storage medium storing a program configured to cause a computer to function as: a confirmation unit configured to confirm a communication state between an information processing apparatus and an external apparatus via a predetermined relay apparatus; and a control unit configured to execute control based on a fact that the confirmed communication state is a predetermined state so that a frequency band used in connection between the information processing apparatus and the predetermined relay apparatus is changed from a first frequency band to a second frequency band different from the first frequency band.

According to the present invention, it is possible to improve convenience in a case where it is impossible to execute communication with an external apparatus via a relay apparatus.

Further features of the present invention will become apparent from the following description of exemplary embodiments with reference to the attached drawings.

### BRIEF DESCRIPTION OF THE DRAWINGS

FIG. 1 is a view showing a system configuration;

FIG. 2 is a block diagram showing the hardware arrangements of an information processing apparatus and an external apparatus;

FIG. 3A and FIG. 3B are a flowchart illustrating processing executed by a setting application;

FIG. 4A and FIG. 4B are a flowchart illustrating processing executed by the setting application;

FIG. 5 is a flowchart illustrating processing executed by the setting application;

FIG. 6 is a view showing a screen displayed by the setting application;

FIG. 7 is a view showing a screen displayed by the setting application;

FIG. 8 is a view showing a screen displayed by the setting application;

FIG. 9 is a flowchart illustrating processing executed by a setting application; and

FIG. 10 is a sequence chart showing processing executed by the information processing apparatus and an access point.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate.

Furthermore, in the attached drawings, the same reference numerals are given to the same or similar configurations, and redundant description thereof is omitted.

When an information processing apparatus communicates with an external apparatus via a relay apparatus, it is sometimes impossible to execute this communication. Therefore, it is necessary to improve convenience in a case where it is impossible to execute communication with the external apparatus via the relay apparatus.

According to one aspect of the present invention, convenience is improved in a case where it is impossible to execute communication with an external apparatus via a relay apparatus.

### First Embodiment

### <System Configuration>

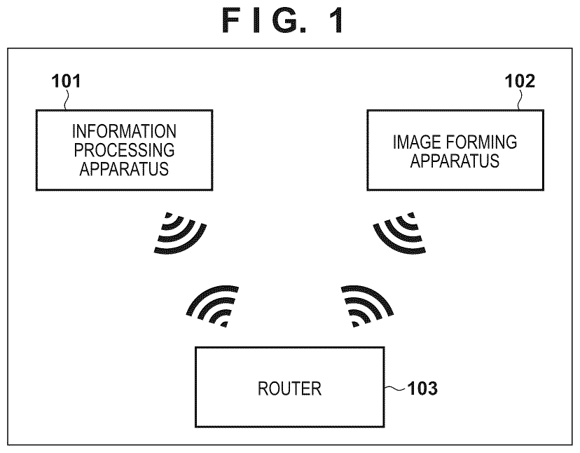

FIG. 1 is a view showing an example of a system according to this embodiment. This system includes an information processing apparatus 101, an image forming apparatus 102, and a router 103. In an example, this system is a wireless communication system in which communication apparatuses such as the information processing apparatus 101, the image forming apparatus 102, and the router 103 can wirelessly communicate with each other via a wireless LAN or the like. Note that the wireless LAN will sometimes be referred to as the WLAN hereinafter. The information processing apparatus 101 can wirelessly communicate with the image forming apparatus 102 via the router 103. That is, the router 103 is a relay apparatus capable of relaying communication. This wireless connection is assumed to use, for example, Wireless Fidelity (Wi-Fi)®. The information processing apparatus 101 needs a printer driver to transmit a print command or the like to the image forming apparatus 102, and the printer driver is installed by a driver installer or the like. At this time, a print port for communicating with the image forming apparatus 102 is created in the information processing apparatus 101, and is used to transmit a print command to the image forming apparatus 102. This allows the image forming apparatus 102 to execute printing from the print command received from the information processing apparatus 101.

Note that a case where the image forming apparatus 102 is used as an external apparatus in this system will be described but the present invention is not limited to this. For example, a Multi Function Peripheral (MFP) such as a scanner, a projector, a mobile terminal, a smartphone, a notebook PC, a tablet terminal, a PDA, a digital camera, a music player, a television, or a smart speaker having a communication function may be used instead of the image forming apparatus 102.

The router 103 is provided separately from (outside) the information processing apparatus 101 and the image forming apparatus 102, and operates as a WLAN base station apparatus. A communication apparatus having a WLAN communication function can communicate in a WLAN infrastructure mode via the router 103 that operates as an access point. Note that the access point will sometimes be referred to as the AP hereinafter. The infrastructure mode will sometimes be referred to as the “infrastructure connection mode” hereinafter. An operation in this mode will be described later. The router 103 performs wireless communication with a (authenticated) communication apparatus for which the router 103 permits connection to the self-apparatus, and relays wireless communication between the communication apparatus and another communication apparatus. The router 103 is connected to, for example, a wired communication network, and can relay communication between a communication apparatus connected to the wired communication network and another communication apparatus wirelessly connected to the router 103.

The router 103 may support a band steering function. The band steering function is a function capable of communicating with a communication apparatus in a plurality of frequency bands such as the 2.4-GHz band and the 5-GHz band. More specifically, for example, the router 103 may comply with Wi-Fi Agile Multiband™. Wi-Fi Agile Multiband is a function of enabling selection of an optimal environment in accordance with the changing status of a Wi-Fi network. More specifically, stations such as the information processing apparatus 101 and the image forming apparatus 102, and APs such as the router 103 exchange information about a network environment using the IEEE 802.11 series communication standard. The station will sometimes be referred to as the STA hereinafter. By this information exchange, when a network is congested, the AP can guide the STA (cause the STA to change the connection destination) to another AP, frequency band, or channel, or in some cases, another cellular service.

Assume that if the router 103 enables the Wi-Fi Agile Multiband function, the same Service Set Identifier (to be referred to as the SSID hereinafter) is set for the router 103 supporting to different frequency bands. That is, the SSID of the router 103 that communicates in the 2.4-GHz band and the SSID of the router 103 that communicates in the 5-GHz band are the same. In addition, assume that the same password is set for the router 103 that communicates in the plurality of frequency bands. That is, the password of the router 103 that communicates in the 2.4-GHz band and the password of the router 103 that communicates in the 5-GHz band are the same.

### <Apparatus Arrangement>

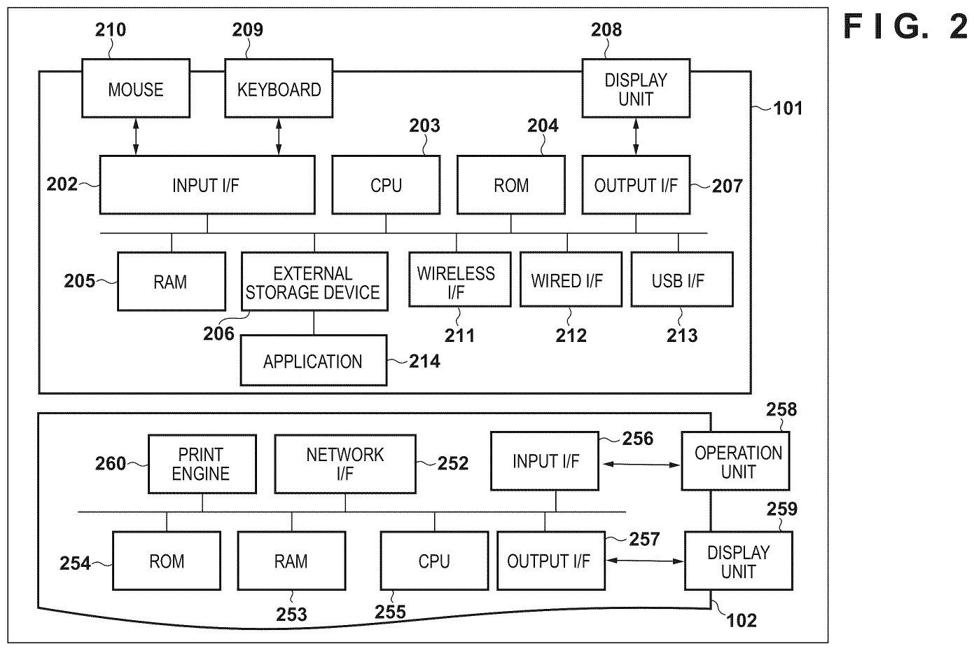

FIG. 2 is a block diagram showing examples of the hardware arrangements of the information processing apparatus 101 and the image forming apparatus 102 according to this embodiment.

A PC will be exemplified as the information processing apparatus 101 but the information processing apparatus 101 is not limited to this. The information processing apparatus 101 may be, for example, a mobile terminal apparatus such as a smartphone or a tablet. The information processing apparatus 101 includes, for example, an input interface (I/F) 202, a CPU 203, a ROM 204, a RAM 205, an external storage device 206, an output interface (I/F) 207, a display unit 208, a keyboard 209, a mouse 210, a wireless interface 211, a wired interface 212, a USB interface 213, and an application program (to be referred to as an application hereinafter) 214. The CPU is an acronym for Central Processing Unit, the ROM is an acronym for Read Only Memory, and the RAM is an acronym for Random Access Memory.

The keyboard 209, the mouse 210, and the like are connected to the input I/F 202. The input I/F 202 acquires information concerning a user operation accepted via an input device such as the keyboard 209 or the mouse 210, and transmits the information to the CPU 203. The display unit 208 as a display device such as a display is connected to the output I/F 207.

The CPU 203 is a system control unit including at least one processor, and controls the overall information processing apparatus 101. The CPU 203 reads out programs stored in a storage medium such as the external storage device 206 and the ROM 204 to the RAM 205 as a work area and executes them, thereby executing various kinds of processes.

The ROM 204 is, for example, a nonvolatile storage, and stores permanent data such as programs to be executed by the CPU 203, data tables, and an embedded operating system (to be referred to as an OS hereinafter) program.

The RAM 205 is formed by a Static Random Access Memory (SRAM) or the like, which needs a backup power supply. Note that the RAM 205 can store important data such as program control variables without volatilization because the data are held by a primary battery (not shown) for data backup. In addition, a memory area for storing setting information of the information processing apparatus 101, management data of the information processing apparatus 101, and the like is also provided in the RAM 205. Furthermore, the RAM 205 is also used as the main memory and work memory of the CPU 203.

The external storage device 206 is, for example, a storage device such as a Hard Disk Drive (HDD) or a Solid State Drive (SSD), and stores an application program group, an Operating System (OS), the driver of the image forming apparatus 102, a print information generation program for generating print information interpretable by the image forming apparatus 102, and other various kinds of data. In this embodiment, the application 214 (to be described later) is also stored in the external storage device 206. A form in which Microsoft Windows® is used as the OS will be exemplified but another OS may be used.

Each of the wireless interface 211, the wired interface 212, and the USB interface 213 is a communication interface that executes data communication with an external device. The wireless interface 211 is an interface that can execute wireless communication with an external device via the router 103 or the like. The wired interface 212 is an interface that can execute wired communication with an external device via the router 103 or the like. The USB interface 213 is an interface that can execute local communication with an external device.

The information processing apparatus 101 executes wireless communication using the wireless interface 211, thereby performing data communication with another device such as the image forming apparatus 102 The wireless interface 211 converts data into a packet, and transmits the packet to another device. The wireless interface 211 restores original data from a packet from another external device, and outputs the data to the CPU 203. The wireless interface 211 is a unit for implementing communication complying with the WLAN standard. The wireless interface 211 can operate concurrently in at least two communication modes including the infrastructure connection mode and the P2P (WLAN) mode. These modes will be described in detail later. Note that frequency bands used in these communication modes can be restricted by the hardware functions and performance. Note that this example assumes that the wireless interface 211 can communicate in both the 2.4- and 5-GHz frequency bands. Note also that the information processing apparatus 101 may be able to communicate in another frequency band.

The application 214 is, for example, an application for executing a network setup of another apparatus (for example, the image forming apparatus 102). Note that, more specifically, the network setup of another apparatus is processing of connecting the other apparatus to an access point such as a router that forms a network.

In this embodiment, the application 214 is not limited to the above-described function of executing the network setup. For example, the application 214 may have a setup function including installation of the driver in the information processing apparatus 101, and acquisition of the license agreement for using the image forming apparatus 102 in various Web services. The application 214 may have other functions in addition to the setup function. For example, the application 214 may have a function of communicating with the image forming apparatus 102 and the router 103. Furthermore, for example, the application 214 may have a function of executing the function of the image forming apparatus 102. For example, the application 214 may have a print function of causing the image forming apparatus 102 to execute printing and a scan function of causing the image forming apparatus 102 to execute scanning. The application 214 may have any one of the print function and the scan function, or may be an application having other functions.

The arrangement of the information processing apparatus 101 is not limited to the above-described one, and the information processing apparatus 101 can appropriately have an arrangement corresponding to a function feasible by a device applied as the information processing apparatus 101. The information processing apparatus 101 may include, for example, a position information acquisition unit that acquires the position information of the information processing apparatus 101. In addition, the information processing apparatus 101 may include a short-distance wireless communication unit (not shown) that is wirelessly connected to an apparatus such as the image forming apparatus 102 at a short distance to execute data communication, and an image capturing unit (not shown) that operates when an application operating on the information processing apparatus 101 executes an image capturing function.

In this embodiment, the image forming apparatus 102 is a printing apparatus (printer) that has a print function of executing printing on a print medium. The image forming apparatus 102 may further have a reading function (scanner), a FAX function, and a telephone function. The image forming apparatus 102 according to this embodiment has a communication function capable of wirelessly communicating with the information processing apparatus 101 and the router 103. A printer will be exemplified below as the image forming apparatus 102.

The image forming apparatus 102 includes a network I/F (interface) 252, a RAM 253, a ROM 254, a CPU 255, a print engine 260, an input interface 256, an output interface 257, an operation unit 258, and a display unit 259.

The network interface 252 is a communication interface that executes data communication with an external device. The network interface 252 is, for example, a wireless interface, a wired interface, a USB interface, or the like. The wireless interface is an interface that can execute wireless communication with an external device via the router 103 or the like. The wired interface is an interface that can execute wired communication with the router 103 or the like via a LAN cable or the like to perform communication with an external device. The USB interface is an interface that can execute local communication with an external device.

The wireless interface is a unit that can provide a WLAN communication function. That is, in accordance with the WLAN standard, the wireless interface converts data into a packet to transmit the packet to another device, and restores original data from a packet from another external device to output the data to the CPU 255. The wireless interface may be able to communicate as a station complying with the IEEE 802.11 standard series. Especially, the wireless interface may be able to communicate as an STA complying with IEEE 802.11a/b/g/n/ac/ax. The wireless interface may also be able to communicate as an STA complying with Wi-Fi Agile Multiband™.

The wireless interface may comply with IEEE 802.11ax, that is, Wi-Fi 6™, and may be able to perform processing complying with IEEE 802.11ax. That is, the image forming apparatus 102 may be able to perform one or both of processing as an STA supporting to (complying with) OFDMA and an operation (processing) as an STA corresponding to (complying with) TWT. OFDMA is an abbreviation for Orthogonal Frequency-Division Multiple Access. TWT is an abbreviation for Target Wake Time. In a case where the image forming apparatus 102 supports to TWT, the timing of data communication from a master unit to an STA is adjusted. The wireless interface (image forming apparatus 102) as the STA shifts the communication function to a sleep state when it need not wait for signal reception. This can suppress power consumption. The wireless interface may also comply with Wi-Fi 6E™. That is, the wireless interface may be able to communicate even in the 6-GHz band (5.925 GHz to 7.125 GHz). A target band present in the 5-GHz band, in which Dynamic Frequency Selection (DFS) is performed, does not exist in the 6-GHz band. In communication in the 6-GHz band, therefore, a communication disconnection caused by the DFS standby time does not occur, and more comfortable communication can be expected.

The RAM 253 is used as the main memory and work memory of the CPU 255, serves as a reception buffer for temporarily saving received print command print data, and saves various kinds of data.

The print engine 260 executes printing based on data saved in the RAM 253.

The ROM 254 stores various kinds of control programs and data used by the respective control programs, and the CPU 255 controls the respective units of the image forming apparatus 102 in accordance with the control programs.

The CPU 255 is a system control unit including at least one processor, and controls the overall image forming apparatus 102. The CPU 255 reads out programs stored in a storage medium such as the ROM 254 to the RAM 253 as a work area and executes them, thereby executing various kinds of processes.

An input device such as the operation unit 258 is connected to the input interface 256. The input interface 256 acquires information concerning a user operation accepted via the operation unit 258, and transmits the information to the CPU 255. The display unit 259 is connected to the output interface 257.

### <Direct Connection Method>

Direct connection is a form in which apparatuses are wirelessly connected directly (that is, by Peer to Peer) without intervention of an external apparatus such as the router 103. Direct connection is also called Peer to Peer connection (P2P connection). As one connection mode, the image forming apparatus 102 can operate in a mode (direct connection mode) for communication by direct connection. In Wi-Fi communication, the mode for communication by direct connection includes a plurality of modes such as a software AP mode and a Wi-Fi Direct (WFD) mode.

A mode in which direct connection is executed by WFD is called a WFD mode. WFD is a standard developed by Wi-Fi Alliance and is a standard included in the IEEE 802.11 communication standards. In the WFD mode, a device serving as a communication partner is searched for by a device search command, then the roles of a P2P group owner (GO) and P2P client are decided, and remaining wireless connection processing is performed. The group owner corresponds to a Wi-Fi master station (master unit), and the client corresponds to a Wi-Fi slave station (slave unit). This role making corresponds to, for example, Go Negotiation in P2P. Note that in the WFD mode in a state before role making is performed, the image forming apparatus 102 is neither the master station nor the slave station. More specifically, first, one of devices to communicate with each other issues a device search command and searches for a device to be connected in the WFD mode. After the other device serving as a communication partner is found, the devices confirm information about services and functions that can be supplied by the respective devices. Note that the device supply information confirmation is an option and is dispensable. The device supply information confirmation phase corresponds to, for example, P2P Provision Discovery. Then, the devices confirm the device supply information and decide, as roles, which device serves as a P2P client and which device serves as a P2P group owner. After the client and the group owner are decided, the devices exchange parameters for performing WFD communication. Based on the exchanged parameters, the P2P client and the P2P group owner perform remaining wireless connection processing and IP connection processing. Note that in the WFD mode, the image forming apparatus 102 may always operate as the GO without executing the above-described GO Negotiation. That is, the image forming apparatus 102 may operate in the WFD mode that is an Autonomous GO mode. The state in which the image forming apparatus 102 operates in the WFD mode is, for example, a state in which WFD connection is not established but the image forming apparatus 102 operates as the GO, or a state in which WFD connection is established and the image forming apparatus 102 operates as the GO.

In the software AP mode, one device (for example, the information processing apparatus 101) among devices (for example, the information processing apparatus 101 and the image forming apparatus 102) to communicate with each other serves as a client that plays a role of requesting various services. The other device implements the function of an AP in Wi-Fi by software setting. The software AP corresponds to a Wi-Fi master station, and the client corresponds to a Wi-Fi slave station. In the software AP mode, the client searches for a device serving as a software AP by a device search command. After the software AP is found, the client and the software AP perform remaining wireless connection processing (establishment of wireless connection and the like) and then IP connection processing (assignment of an IP address and the like). Note that commands and parameters transmitted/received when implementing wireless connection between the client and the software AP suffice to be those defined by the Wi-Fi standard, and a description thereof will be omitted here.

In this embodiment, when the image forming apparatus 102 establishes and maintains direct connection, it operates as a master station in a network to which the image forming apparatus 102 belongs. Note that the master station is an apparatus that constructs a wireless network, and is an apparatus that provides a slave station with parameters used in connection to the wireless network. The parameters used in connection to the wireless network are, for example, parameters about a channel used by the master station. The slave station receives the parameters and is connected to the wireless network constructed by the master station by using the channel used by the master station. In the direct connection mode, the image forming apparatus 102 operates as the master station and can decide a specific frequency band and channel used for communication in the direct connection mode. In this embodiment, the image forming apparatus 102 can use a channel corresponding to the 2.4-GHz frequency band and a channel corresponding to the 5-GHz frequency band for communication in the direct connection mode.

### <Infrastructure Connection Method>

Infrastructure connection is a connection form in which devices (for example, the information processing apparatus 101 and the image forming apparatus 102) to communicate with each other are connected to an AP (for example, the router 103) that controls a network of the devices, and the devices communicate with each other via the AP. As one connection mode, the image forming apparatus 102 can operate in a mode (infrastructure connection mode) for communication in infrastructure connection.

In infrastructure connection, each device searches for an AP by a device search command. After an AP is found, the device and the AP perform remaining wireless connection processing (establishment of wireless connection and the like) and then IP connection processing (assignment of an IP address and the like). Note that commands and parameters transmitted/received when implementing wireless connection between the device and the AP suffice to be those defined by the Wi-Fi standard, and a description thereof will be omitted here.

In this embodiment, when the image forming apparatus 102 operates in infrastructure connection, the router 103 operates as a master station and the image forming apparatus 102 operates as a slave unit. That is, in this embodiment, infrastructure connection means connection between the image forming apparatus 102 operating as a slave unit and the apparatus operating as a master unit. When the image forming apparatus 102 establishes infrastructure connection and the information processing apparatus 101 also establishes infrastructure connection to the router 103, the image forming apparatus 102 and the information processing apparatus 101 can communicate with each other via the router 103. Since the router 103 decides a channel used for communication in infrastructure connection, the image forming apparatus 102 executes communication in infrastructure connection by using the channel decided by the router 103. In this embodiment, the image forming apparatus 102 can use a channel corresponding to the 2.4-GHz frequency band and a channel corresponding to the 5-GHz frequency band for communication in infrastructure connection. Note that the image forming apparatus 102 can also use a channel corresponding to the DFS band in the 5-GHz frequency band for communication in infrastructure connection. To communicate with the image forming apparatus 102 via the router 103, the information processing apparatus 101 needs to recognize that the image forming apparatus 102 belongs to a network which is formed by the router 103 and to which the information processing apparatus 101 belongs.

### <Wireless Setting Processing (Network Setup Processing)>

According to this embodiment, by using wireless communication with the image forming apparatus 102, the information processing apparatus 101 executes connection setting (network setting) as setting for operating the image forming apparatus 102 by at least one communication method out of the infrastructure connection method and the direct connection method. The connection setting processing according to this embodiment is executed by wireless communication, and is thus called a cableless setup (CLS). Note that the connection setting processing may be executed by wired communication. In a case where the application 214 stored in the external storage device 206 or the like is activated, the information processing apparatus 101 performs the connection setting processing for the image forming apparatus 102. That is, the image forming apparatus 102 can operate in a connection setting mode (connection setting state) as a mode for executing the connection setting processing, and executes the connection setting processing in a state in which the image forming apparatus 102 operates in the connection setting mode. Details of the connection setting mode will be described later. Note that the connection setting mode is also a mode in a case where a network setup for connecting the image forming apparatus 102 to the router 103 is performed, as will be described later. That is, the connection setting mode can be said as a network setup mode. In other words, the connection setting processing is network setup processing.

When operating the image forming apparatus 102 in the infrastructure connection mode, the information processing apparatus 101 wirelessly transmits, to the image forming apparatus 102, infrastructure setting information as setting information for operating the image forming apparatus 102 in the infrastructure connection mode. The infrastructure setting information includes information concerning the router 103. The information concerning the router 103 is, for example, information concerning a Service Set Identifier (SSID), a password, and a frequency band.

On the other hand, when operating the image forming apparatus 102 in the direct connection mode, the information processing apparatus 101 wirelessly transmits, to the image forming apparatus 102, direct setting information as setting information for operating the image forming apparatus 102 in the direct connection mode. The direct setting information includes an instruction to enable the WFD function to operate the image forming apparatus 102 as a group owner or to enable the access point setting of the image forming apparatus 102. The information processing apparatus 101 acquires, from the image forming apparatus 102, connection information necessary for direct connection to the image forming apparatus 102. The connection information necessary for direct connection to the image forming apparatus 102 includes, for example, information of the SSID, password, and the like of the image forming apparatus 102.

In this embodiment, in the connection setting processing, to transmit the infrastructure setting information or the direct setting information and acquire the information for direct connection to the image forming apparatus 102, direct connection for connection setting between the information processing apparatus 101 and the image forming apparatus 102 is used. Then, in this embodiment, the connection setting processing using Wi-Fi is executed as direct connection for connection setting. However, for example, a wireless communication standard other than Wi-Fi, such as Bluetooth, may be used, or a wired communication standard such as a wired LAN or Universal Serial Bus (USB) may be used.

After infrastructure connection by Wi-Fi or direct connection is established between the information processing apparatus 101 and the image forming apparatus 102 by the connection setting processing, the information processing apparatus 101 and the image forming apparatus 102 can communicate with each other via the established connection. More specifically, for example, the information processing apparatus 101 can transmit, to the image forming apparatus 102 via the established connection, a print job for causing the image forming apparatus 102 to execute printing or a scan job for causing the image forming apparatus 102 to execute scanning. Note that in this embodiment, it is possible to operate the image forming apparatus 102 in the infrastructure connection mode and operate the image forming apparatus 102 in the direct connection mode by the connection setting processing, but the present invention is not limited to this form. For example, it may be possible to only operate the image forming apparatus 102 in the infrastructure connection mode (that is, it may be impossible to operate the image forming apparatus 102 in the direct connection mode) by the connection setting processing.

### <Connection Setting Mode (Network Setup Mode)>

The image forming apparatus 102 can operate in the connection setting mode. A trigger for the image forming apparatus 102 to start an operation in the connection setting mode may be, for example, pressing a connection setting mode button by the user or activating (turning on) the image forming apparatus 102 for the first time after arrival. The connection setting mode button may be a hardware button of the image forming apparatus 102 or a software button displayed on the display unit 259 by the image forming apparatus 102.

When the image forming apparatus 102 starts an operation in the connection setting mode, it enables both Wi-Fi communication and Bluetooth Low Energy (BLE) communication. More specifically, as Wi-Fi communication enabling processing, the image forming apparatus 102 enables an internal AP (connection setting AP) of the image forming apparatus 102 that is dedicated to the connection setting mode. Then, the image forming apparatus 102 can establish direct connection to the information processing apparatus 101 by Wi-Fi. Connection information (SSID and password) for connection to the connection setting AP is held in advance in a setup application (the application 214) installed in the information processing apparatus 101, and the information processing apparatus 101 recognizes in advance the connection information for connection to the connection setting AP. Note that a form in which an encryption method is not set for the connection setting AP and a password is unnecessary for connection to the AP may be adopted. Therefore, unlike the connection information of the AP enabled in the direct connection mode, the connection information for connection to the connection setting AP cannot be changed arbitrarily by the user. Note that in the connection setting mode, the image forming apparatus 102 may be connected to the information processing apparatus 101 by not normal Wi-Fi but Wi-Fi Direct (WFD). That is, the image forming apparatus 102 may operate as a group owner and receive a setting command from the information processing apparatus 101 by WFD communication.

### <Processing Executed by Wi-Fi Agile Multiband>

As described above, the information processing apparatus 101 according to this embodiment complies with Wi-Fi Agile Multiband. Wi-Fi Agile Multiband is a function complying with the IEEE 802.11v, IEEE 802.11r, or IEEE 802.11k standard, and is a function of controlling the information processing apparatus 101 to be connected to an appropriate network in accordance with the state of the network around the information processing apparatus 101.

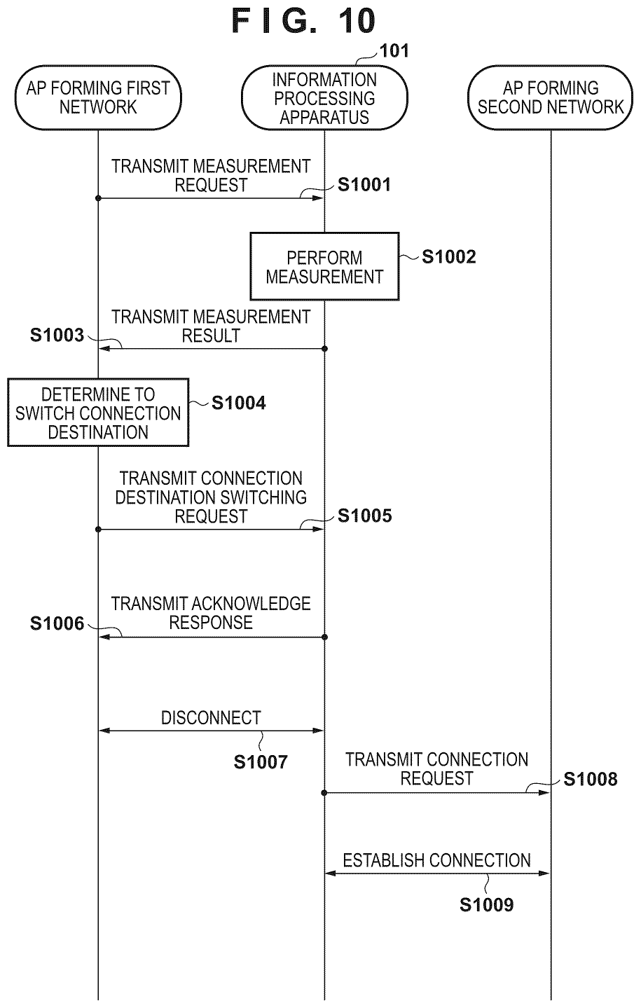

FIG. 10 is a sequence chart showing processing executed by Wi-Fi Agile Multiband. Processes executed by each apparatus in this sequence are implemented by reading out various programs stored in the memory such as the ROM of each apparatus to the RAM and executing them by the CPU of each apparatus. Note that the processing executed by the information processing apparatus 101 is executed by the OS of the information processing apparatus 101 based on settings of Wi-Fi Agile Multiband which are set in the OS. In the description of FIG. 10, assume that there exist, around the information processing apparatus 101, the first network as a network to which the information processing apparatus 101 is currently connected and the second network as a network to which the information processing apparatus 101 is not currently connected. An access point forming the first network is, for example, an access point that is enabled by the router 103. Note that an access point forming the first network and an access point forming the second network may be the same or different. That is, for example, both the access point forming the first network and the access point forming the second network may simultaneously be enabled by the same router 103. In a case where the access point forming the first network and the access point forming the second network are the same, for example, a frequency band used in the first network is different from that used in the second network. Then, the processing shown in FIG. 10 is started in a state in which the information processing apparatus 101 operates in the infrastructure connection mode and is connected to the first network. Furthermore, when connection between the information processing apparatus 101 and the access point forming the first network is established, the access point acquires information representing whether the information processing apparatus 101 complies with IEEE 802.11v. Assume that if it is specified based on the information that the information processing apparatus 101 complies with IEEE 802.11v, the following processing is executed. That is, in other words, the information representing whether the information processing apparatus 101 complies with IEEE 802.11v is information representing whether the information processing apparatus 101 complies with Wi-Fi Agile Multiband. Assume that processing to be described below is implemented by the Wi-Fi Agile Multiband function of the information processing apparatus 101 or the access point forming the first network. In addition, the processing of the sequence chart is executed in, for example, a state in which a priority frequency band is not set in the OS or a state in which a priority frequency band is set in the OS but is not used in connection between the information processing apparatus 101 and the first network.

In S1001, the access point forming the first network transmits measurement requests to the information processing apparatus 101. To transmit measurement requests, for example, a mechanism defined by the IEEE 802.11k standard is used.

In S1002, the information processing apparatus 101 starts measurement of values concerning one or a plurality of networks around the information processing apparatus 101 based on the measurement requests received in S1001. More specifically, the value concerning the network around the information processing apparatus 101 is the radio field intensity of information received by the information processing apparatus 101. More specifically, the information received by the information processing apparatus 101 is information corresponding to the one or plurality of networks around the information processing apparatus 101, and information transmitted by an access point forming the network around the information processing apparatus 101. Note that the information may be a beacon or frame. Note also that if there exist the plurality of networks around the information processing apparatus 101, the radio field intensity of information corresponding to each of the plurality of networks is measured. In this example, the radio field intensity of information corresponding to the first network and transmitted from the access point forming the first network and the radio field intensity of information corresponding to the second network and transmitted from the access point forming the second network are measured. Note that the information acquired by the information processing apparatus 101 in this processing is not limited to information concerning the radio field intensity of the information received by the information processing apparatus 101. For example, an SSID as identification information of the network corresponding to the information received by the information processing apparatus 101, information concerning a frequency band used in the network, information concerning a channel used in the network, information concerning the number of apparatuses connected to the network, and the like may also be acquired. Identification information of an access point that transmits a beacon may also be acquired. For example, the identification information of the access point is a BSSID, and is a MAC address.

In S1003, the information processing apparatus 101 specifies and extracts information corresponding to a network having the same SSID as that of the first network from the pieces of information acquired in S1002. Then, the information processing apparatus 101 transmits, as a response to the request received in S1001, the information extracted from the pieces of information acquired in S1002 to the access point forming the first network, and does not transmit the information that has not been extracted from the pieces of information acquired in S1002 to the access point forming the first network. In this example, since the SSID of the first network and the SSID of the second network are the same, at least the information corresponding to the second network is transmitted to the access point forming the first network. Note that the information concerning the network having the same SSID as that of the first network is, for example, identification information of each access point that forms the network and is found by the information processing apparatus 101 or identification information of the network.

In S1004, based on the information received from the information processing apparatus 101, the access point forming the first network determines whether to switch (change) the connection destination of the information processing apparatus 101 from the first network to another network. This determination processing is processing of determining whether communication between the other network and the information processing apparatus 101 is more stable than communication between the first network and the information processing apparatus 101. This determination processing is processing performed by comprehensively referring to the radio field intensity and frequency band specified based on the information received from the information processing apparatus 101, the number of apparatuses connected to the network, and the like. Note that in this determination processing, information other than the information received from the information processing apparatus 101 may be referred to. The information other than the information received from the information processing apparatus 101 is, for example, information collected by the access point forming the first network, and includes information concerning the number of apparatuses connected to the access point forming the first network and information concerning a speed and an amount of data communicated on the first network. If it is determined to switch the connection destination of the information processing apparatus 101 from the first network to the other network, the access point forming the first network specifies the new connection destination of the information processing apparatus 101. Note that in this example, any of the networks specified by the information received from the information processing apparatus 101 and existing around the information processing apparatus 101 is specified as the new connection destination of the information processing apparatus 101. A network specified by the Wi-Fi Agile Multiband function and specified as the new connection destination of the information processing apparatus 101 will be referred to as a change target network hereinafter. In this description, assume that the change target network is the second network. Next, the access point forming the first network specifies information concerning the second network. More specifically, the information concerning the second network includes, for example, the SSID of the second network, the frequency band used in the second network, and the channel used in the second network. Note that the access point forming the first network may specify a plurality of networks as new connection destinations of the information processing apparatus 101, and specify information concerning each of the plurality of networks.

In S1005, the access point forming the first network transmits a connection destination switching request to the information processing apparatus 101. The connection destination switching request includes information concerning the network specified, in S1004, as the new connection destination of the information processing apparatus 101. For example, the connection destination switching request is transmitted as a BSS Transition Management (BTM) Request by a BTM Request frame defined by the IEEE 802.11v standard. The information concerning the network specified as the new connection destination of the information processing apparatus 101 is, for example, identification information of the access point forming the second network.

Note that the access point forming the first network may specify a plurality of networks as new connection destinations of the information processing apparatus 101 from the plurality of networks corresponding to the information received from the information processing apparatus 101. Then, the connection destination switching request may include a list of pieces of identification information of a plurality of access points forming the same network as that of the first access point. In this case, the information processing apparatus 101 may select any of the plurality of access points, and switch the connection destination of the information processing apparatus 101 to the selected access point.

In S1006, if the information processing apparatus 101 complies with the connection destination switching request received in S1005, the information processing apparatus 101 transmits, to the access point forming the first network, a response (acknowledgement response) representing approval of switching of the connection destination. If the information processing apparatus 101 does not comply with the connection destination switching request, the information processing apparatus 101 may transmit, to the access point forming the first network, a response representing rejection of switching of the connection destination. The response is transmitted as a BTM Response. In this description, assume that a response representing approval of switching of the connection destination is transmitted. Then, the information processing apparatus 101 specifies the second network as the switching destination of the connection destination based on the connection destination switching request received in S1005. The information processing apparatus 101 also specifies a channel used in the second network. Note that if the connection destination switching request includes pieces of information corresponding to a plurality of networks, the information processing apparatus 101 specifies any of the networks as the second network. At this time, a network to be selected may be decided in accordance with an arbitrary condition. As described above, for the connection destination switching request, the BSSID of the access point is used as the identification information of the network or the identification information of the access point. Then, if one access point forms a plurality of networks, the connection destination switching request includes two or more pieces of information corresponding to different networks and the two or more pieces of information may include identical BSSIDs. In this case, the information processing apparatus 101 discriminates the networks based on pieces of channel information included in the two or more pieces of information. This is because even if one access point forms a plurality of networks, channels used by the plurality of networks are different. Then, if the connection destination switching request includes only information corresponding to one network, the information processing apparatus 101 specifies the network corresponding to the information as the second network.

In S1007, the information processing apparatus 101 disconnects from the first network.

In S1008, the information processing apparatus 101 uses the channel specified in S1006 to transmit, to the access point forming the second network, a connection request for connection to the second network. Note that as a password used by the information processing apparatus 101 for connection to the second network and transmitted from the information processing apparatus 101 to the apparatus forming the second network, the same password as that used by the information processing apparatus 101 for connection to the first network is used. That is, after the connection is disconnected from the first network, the information processing apparatus 101 can specify a password to be used for connection to the second network without accepting input of the password for connection to the second network from the user or receiving the password from another apparatus.

In S1009, connection between the information processing apparatus 101 and the second network is established.

As described above, it is possible to appropriately control the network as the connection destination of the information processing apparatus 101 by the Wi-Fi Agile Multiband function.

Note that the form in which the connection destination of the information processing apparatus 101 is changed from the first network to the second network by the Wi-Fi Agile Multiband function has been described above. However, a plurality of access points may cooperatively form one network. More specifically, the network cooperatively formed by the plurality of access points is, for example, a mesh network. In this case, the connection destination can be changed by the Wi-Fi Agile Multiband function in one network. In other words, this embodiment may be a form in which the first access point to which the information processing apparatus 101 has been connected from the start of this flowchart is switched to the second access point that forms the same network as that of the first access point. Therefore, the above-described connection to the second network can be said as connection to the access point that forms the same network as the first network.

As described above, when a network setup for connecting the image forming apparatus 102 to the router 103 is performed using the information processing apparatus 101, the information processing apparatus 101 and the image forming apparatus 102 can communicate with each other via the router 103. In a status in which the information processing apparatus 101 and the image forming apparatus 102 are connected to the router 103, the connection destination of the information processing apparatus 101 may be switched by Wi-Fi Agile Multiband. Then, by switching the connection destination, a frequency band used in connection to the new connection destination of the information processing apparatus 101 may be different from a frequency band used in connection to the access point by the image forming apparatus 102 as a partner that communicates with the information processing apparatus 101 via infrastructure connection. More specifically, for example, in a state in which both the information processing apparatus 101 and the image forming apparatus 102 are connected to the access point corresponding to the 2.4-GHz band enabled by the router 103, the connection destination of the information processing apparatus 101 may be switched by Wi-Fi Agile Multiband. This may set a state in which the information processing apparatus 101 is connected to the access point corresponding to the 5-GHz band enabled by the router 103, and the image forming apparatus 102 is connected to the access point corresponding to the 2.4-GHz band enabled by the router 103. If the frequency band used by the information processing apparatus 101 for communication via the infrastructure connection is different from the frequency band used by the image forming apparatus 102 for communication via the infrastructure connection, it may be impossible to perform communication via the infrastructure connected between the information processing apparatus 101 and the image forming apparatus 102 and the communication speed of the communication may lower. These problems can also arise due to an operation other than switching of the connection destination of the information processing apparatus 101 by Wi-Fi Agile Multiband. For example, these problems arise when the information processing apparatus 101 connects the image forming apparatus 102 to the router 103 in the 2.4-GHz frequency band and is then connected to the router 103 in the 5-GHz frequency band without using the Wi-Fi Agile Multiband function. In this embodiment, control for solving the above-described problems is executed.

In this embodiment, the computer (for example, the CPU 203) of the information processing apparatus 101 is caused to execute communication confirmation to confirm the communication state with an external apparatus such as the image forming apparatus 102 via the router 103 serving as an AP. If it is confirmed, by the communication confirmation, that the communication state with the external apparatus via the router 103 is a communication disable state, the frequency band used by the wireless interface 211 of the information processing apparatus 101 is changed. A form in which the communication state with the external apparatus via the router 103 is confirmed based on the change of the frequency band used by the wireless interface 211 of the information processing apparatus 101 will be described. This form can improve convenience in a case where it is impossible to perform communication with the image forming apparatus 102 via the router 103.

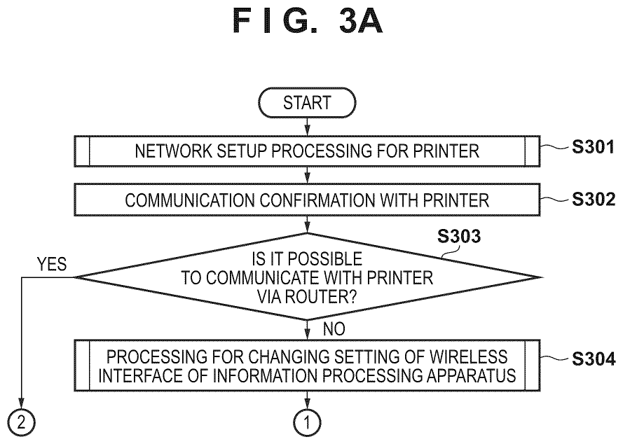

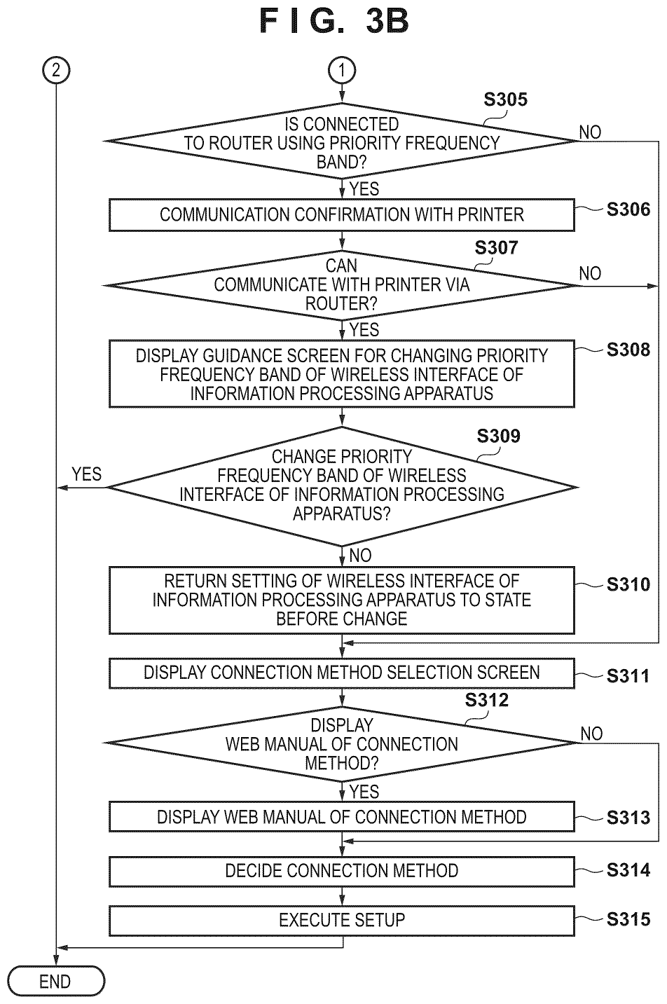

FIG. 3A and FIG. 3B are a flowchart illustrating processing executed by the application 214 of this system. In this flowchart, the processing executed by the application 214 is implemented by, for example, deploying a control program stored in the memory such as the ROM 204 into the RAM 205 and executing it by the CPU 203. For example, when the user activates the application 214 installed in the information processing apparatus 101, the application 214 executes the processing shown in FIG. 3A and FIG. 3B.

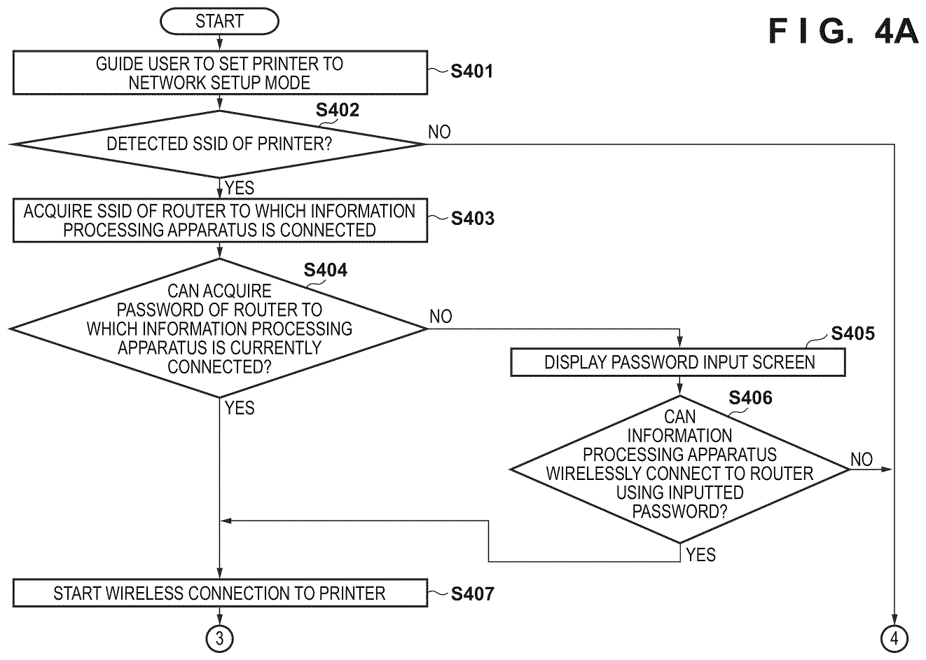

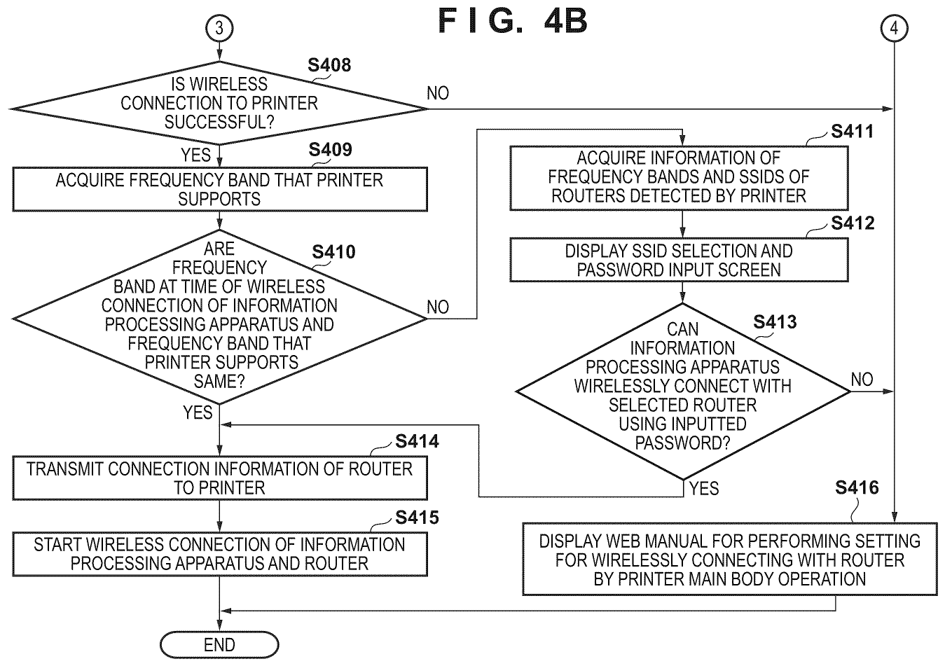

In step S301, the application 214 executes network setup processing. The network setup processing is processing for connecting the image forming apparatus 102 to the router 103. Details of the processing in step S301 will be described later with reference to FIG. 4A and FIG. 4B.

In step S302, the application 214 performs communication confirmation to confirm whether the information processing apparatus 101 can communicate with the image forming apparatus 102 via the router 103. The communication confirmation is performed by, for example, communication by the above-described infrastructure connection. For example, the application 214 designates the identification information of the image forming apparatus 102, and requests a response from the image forming apparatus 102 by a predetermined protocol.

More specifically, for example, the application 214 designates an Object IDentifier (OID) representing the device name or serial number of the image forming apparatus 102. Then, the application 214 requests a response from the image forming apparatus 102 by broadcasting, by a Simple Network Management Protocol (to be referred to as an SNMP hereinafter), a Get Request command onto the network formed by the router 103 to which the information processing apparatus 101 is connected. For example, the application 214 may instruct the OS of the information processing apparatus 101 to execute these processes.

In step S303, the application 214 determines whether the information processing apparatus 101 can communicate with the image forming apparatus 102 via the router 103. If the application 214 receives the response from the image forming apparatus 102 by the processing executed in step S302, the application 214 determines that communication is possible. If the application 214 does not receive the response from the image forming apparatus 102 by the processing executed in step S302, the application 214 determines that communication is impossible. If the application 214 determines that communication is possible, the processing shown in FIG. 3A and FIG. 3B ends. On the other hand, if the application 214 determines that communication is impossible, the process advances to step S304. Note that even if the information processing apparatus 101 can communicate with the image forming apparatus 102 via the router 103, if the communication quality of communication between the information processing apparatus 101 and the image forming apparatus 102 via the router 103 is low, the application 214 may advance to step S304. That is, in this processing, the application 214 may specify the communication quality between the information processing apparatus 101 and the image forming apparatus 102. Then, if the specified quality is equal to or higher than a predetermined threshold, the application 214 may end the processing shown in FIG. 3A and FIG. 3B, and if the specified quality is lower than the predetermined threshold, the application 214 may advance to step S304. More specifically, for example, the communication quality indicates transmission quality, connection quality, and stability quality. That is, in this processing, the application 214 determines whether the communication between the information processing apparatus 101 and the image forming apparatus 102 via the router 103 is in the first state or the second state in which the communication quality is lower than in the first state, and switches the processing based on the result. The second state includes a state in which it is impossible to perform communication between the information processing apparatus 101 and the image forming apparatus 102 via the router 103 and a state in which it is possible to perform communication between the information processing apparatus 101 and the image forming apparatus 102 via the router 103 but the communication quality is low. A case where the communication between the information processing apparatus 101 and the image forming apparatus 102 via the router 103 is in the second state is, for example, a specific case where a frequency band used in connection between the information processing apparatus 101 and the router 103 is different from a frequency band used in connection between the image forming apparatus 102 and the router 103. More specifically, the specific case is, for example, a case where information transmitted to the image forming apparatus 102 by the network setup processing is information corresponding to a frequency band different from the frequency band used in connection between the information processing apparatus 101 and the router 103. More specifically, the specific case is, for example, a case where even though the frequency band used in connection between the information processing apparatus 101 and the router 103 is the same as the frequency band used in connection between the image forming apparatus 102 and the router 103, the frequency band used in connection between the information processing apparatus 101 and the router 103 is switched by executing the Wi-Fi Agile Multiband function in that state.

The processing in step S303 is determined in accordance with, for example, whether the image forming apparatus 102 can be detected via the router 103. More specifically, for example, if the image forming apparatus 102 belongs to the same network as that of the information processing apparatus 101, the information processing apparatus 101 can receive a response of the image forming apparatus 102 to the Get Response command transmitted from the information processing apparatus 101 as described in step S302. This detects the image forming apparatus 102 via the router 103. That is, if a response of the image forming apparatus 102 to the Get Response command is received, it is determined in step S303 that communication is possible. On the other hand, if the image forming apparatus 102 does not belong to the same network as that of the information processing apparatus 101, the image forming apparatus 102 does not transmit, to the information processing apparatus 101, a response to the Get Response command. In other words, the image forming apparatus 102 is not detected via the router 103. That is, if the information processing apparatus 101 cannot receive a response from the image forming apparatus 102, it is determined in step S303 that communication is impossible. The application 214 may inquire of the OS of the information processing apparatus 101 about whether the image forming apparatus 102 can be detected via the router 103.

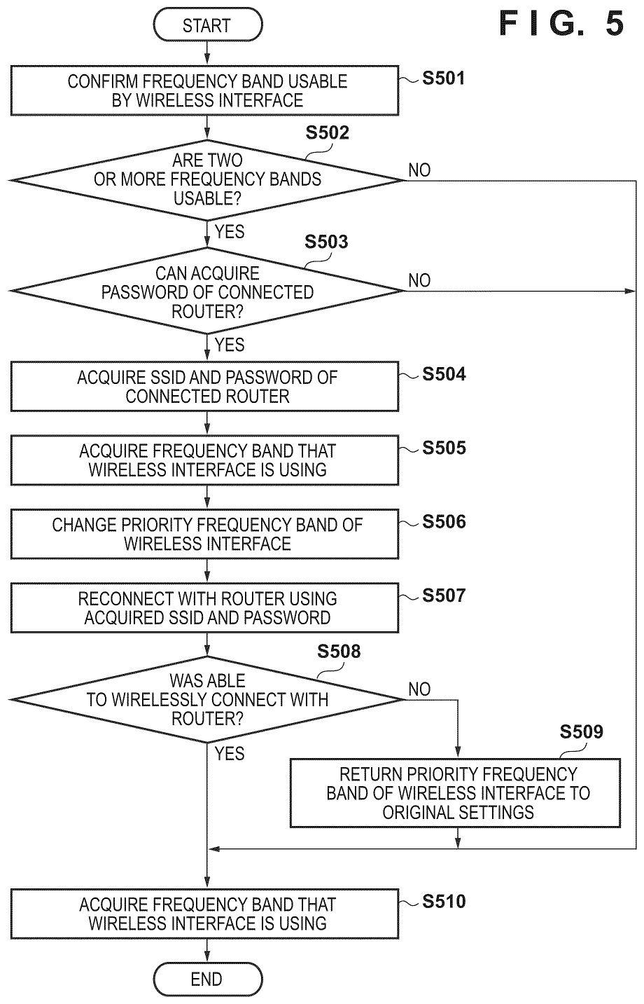

In step S304, the application 214 performs processing of changing the setting of the wireless interface 211 of the information processing apparatus 101. Note that this processing will be described later with reference to FIG. 5 (to be described later).

In step S305, the application 214 determines whether the information processing apparatus 101 is wirelessly connected to the router 103 using the priority frequency band by the processing in step S304. The frequency band prioritized by the wireless interface 211 of the information processing apparatus 101 will sometimes be referred to as the priority frequency band hereinafter. If the application 214 determines that the information processing apparatus 101 is wirelessly connected using the priority frequency band, the process advances to step S306. On the other hand, if the application 214 determines that the information processing apparatus 101 is not wirelessly connected using the priority frequency band, the process advances to step S311. More specifically, in step S510 of FIG. 5 to be described later, the application 214 performs processing of acquiring the frequency band used by the wireless interface 211 of the information processing apparatus 101. The application 214 performs the determination processing in step S305 based on the frequency band used by the wireless interface 211 of the information processing apparatus 101, which has been acquired in step S510.

In step S306, the application 214 performs communication confirmation to confirm whether the information processing apparatus 101 can communicate with the image forming apparatus 102 via the router 103. Note that the communication confirmation in step S306 is the same as the processing in step S302, and this processing can thus be said as reconfirmation processing of executing reconfirmation. The communication confirmation in step S306 is the same as the processing in step S302 and a description thereof will be omitted.

In step S307, the application 214 determines whether the information processing apparatus 101 can communicate with the image forming apparatus 102 via the router 103. If the application 214 determines that communication is possible, the process advances to step S308. On the other hand, if the application 214 determines that communication is impossible, the process advances to step S311. In step S307, the determination processing is performed based on the result of the communication confirmation in step S306. The determination processing in step S307 is the same as the processing in step S303 and a description thereof will be omitted.

In step S308, the application 214 displays a screen for guiding to change the priority frequency band of the wireless interface 211 of the information processing apparatus 101. The screen for guiding to change the priority frequency band of the wireless interface 211 of the information processing apparatus 101 will sometimes be referred to as a priority frequency band change guidance screen hereinafter.

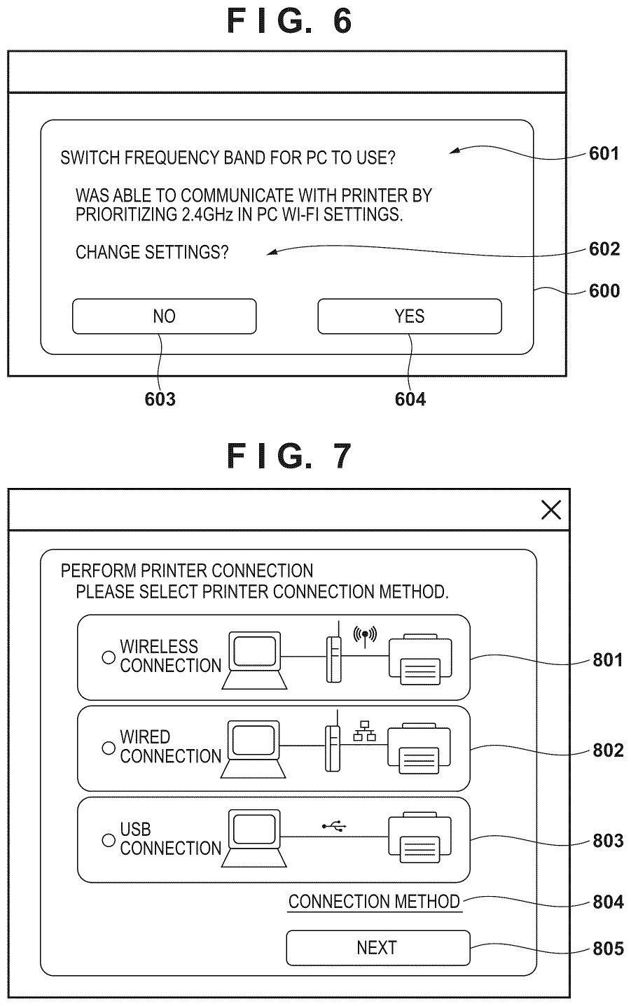

Reference is now made to FIG. 6. FIG. 6 is a view showing an example of the change guidance screen displayed by the application 214 on the display unit 208 of the information processing apparatus 101 in step S308. For example, the application 214 controls not to accept an instruction to close the change guidance screen. For example, the application 214 may execute display control not to display or to gray out an interface (button) that can accept an instruction to close the change guidance screen.

A dialog 600 is displayed on the change guidance screen. The dialog 600 is a display representing that the priority frequency band of the information processing apparatus 101 is changed. On the dialog 600, for example, a title 601, an explanatory note 602, buttons 603 and 604, and the like are displayed. The title 601 is, for example, a message for prompting to change the priority frequency band of the wireless interface 211 of the information processing apparatus 101. The explanatory note 602 is a message indicating that the information processing apparatus 101 can communicate with the image forming apparatus 102 by changing the frequency band of the wireless interface 211 of the information processing apparatus. That is, the change guidance screen can be said as a screen that displays the result of confirmation of communication of the information processing apparatus 101 with the image forming apparatus 102 via the router 103. The explanatory note 602 also includes a message for inquiring of the user about whether to change the setting of the priority frequency band. The button 603 is an interface that can accept an instruction not to change the setting of the priority frequency band of the wireless interface 211. The button 604 is an interface that can accept an instruction to change the setting of the priority frequency band of the wireless interface 211. As described above, when the dialog 600 is displayed on the display unit 208, the user can recognize that the frequency band used by the information processing apparatus 101 has been changed, and can set whether to change the frequency band.

In step S309, the application 214 determines whether to change the priority frequency band of the wireless interface 211 of the information processing apparatus 101. If the application 214 determines to change the setting of the priority frequency band, the processing shown in FIG. 3A and FIG. 3B ends. On the other hand, if the application 214 determines not to change the setting of the priority frequency band, the process advances to step S310. More specifically, for example, the processing in step S309 is determined based on a user operation on the priority frequency band change guidance screen displayed in step S308 described above. For example, if the user presses the button 603 on the priority frequency band change guidance screen, the application 214 determines not to change the setting of the priority frequency band (NO in step S309). On the other hand, if the user presses the button 604, the application 214 determines to change the setting of the priority frequency band (YES in step S309).

In step S310, the application 214 returns the setting of the wireless interface 211 of the information processing apparatus 101 to the state before the change processing in step S304. For example, the application 214 instructs the OS of the information processing apparatus 101 to return the setting of the wireless interface 211 of the information processing apparatus 101 to the state before the change processing in step S304.

In step S311, the application 214 displays a selection screen of a connection method of the image forming apparatus 102. Reference is now made to FIG. 7. FIG. 7 is a view showing an example of the selection screen of the connection method of the image forming apparatus 102. On the selection screen of the connection method, selection items 801 to 803 of the connection method of the image forming apparatus 102, a button 804, a button 805, and the like are displayed.

For each of the selection items 801 to 803, a checkbox capable of accepting a selection instruction, the connection method of the image forming apparatus 102, an icon representing the connection method, and the like are displayed. That is, the selection screen shown in FIG. 7 is a screen that can accept an instruction of the connection method for connecting the information processing apparatus 101 and the image forming apparatus 102. In this example, the selection item 801 for connecting the information processing apparatus 101 and the image forming apparatus 102 by wireless connection, the selection item 802 for connecting the information processing apparatus 101 and the image forming apparatus 102 by wired connection, and the selection item 803 for connecting the information processing apparatus 101 and the image forming apparatus 102 by USB connection are displayed. That is, the selection screen shown in FIG. 7 is a screen that displays the connection methods including wired connection and USB connection in addition to wireless connection. The connection method is a connection form for setting a state in which the information processing apparatus 101 and the image forming apparatus 102 can communicate with each other by wireless connection or wired connection, and is not limited to the connection method via the router 103. As described above, when the plurality of connection methods (selection items 801 to 803) including wired connection are displayed, even if the information processing apparatus 101 cannot communicate with the image forming apparatus 102 via the router 103, the user can select another connection method.

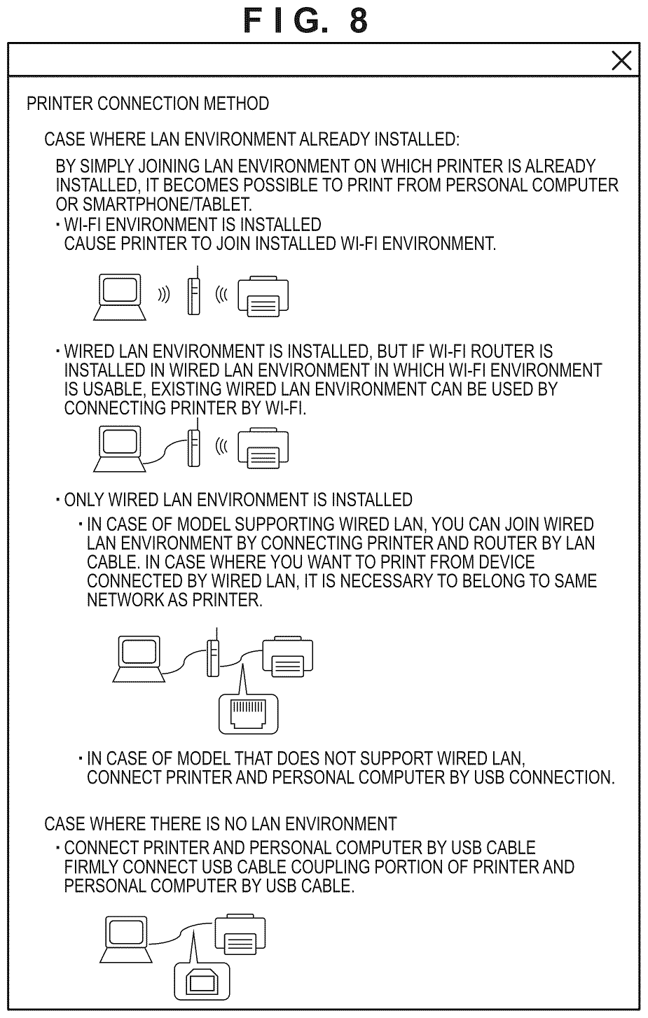

The button 804 is, for example, an interface (link button) that can accept an instruction to display a detailed guidance about the connection method. The detailed guidance about the connection method is, for example, a Web manual in which the connection method for causing the information processing apparatus 101 and the image forming apparatus 102 to communicate with each other is described. The Web manual will be described with reference to FIG. 8 (to be described later).

The button 805 is, for example, an interface that can accept an instruction to decide the connection method between the information processing apparatus 101 and the image forming apparatus 102. For example, the user can press the button 805 after selecting one of the selection items 801 to 803, thereby confirming the selected connection method.

In step S312, the application 214 determines whether to display the guidance about the connection method. If the application 214 determines to display the guidance, the process advances to step S313. On the other hand, if the application 214 determines not to display the guidance, the process advances to step S314. More specifically, for example, the application 214 performs the determination processing in step S312 based on a user operation on the selection screen of the connection method displayed in step S311. If the user presses the button 805 on the selection screen of the connection method, the application 214 determines to display the guidance about the connection method (YES in step S312). On the other hand, if the user does not press the button 805, the application 214 determines not to display the guidance screen of the connection method (NO in step S312).

In step S313, the application 214 displays the guidance of the connection method. More specifically, for example, the application 214 may designate the link (URL) of the Web manual to the OS of the information processing apparatus 101 and instruct to activate the browser. The application 214 may acquire the model information of the image forming apparatus 102 to display the Web manual. The model information of the image forming apparatus 102 may be, for example, information representing the model name, SSID, device name, model number, and model year of the image forming apparatus 102. The application 214 may display the Web manual corresponding to the model of the image forming apparatus 102. For example, the application 214 may generate a URL for displaying the Web manual corresponding to the model of the image forming apparatus 102, and activate the browser to display the Web manual of the target model.

Reference is now made to FIG. 8. FIG. 8 is a view showing an example of the Web manual displayed by the processing in step S312. In the Web manual, details of the connection method for causing the information processing apparatus 101 and the image forming apparatus 102 to communicate with each other are described. In the Web manual, for example, the connection method in a case where the router 103 is already installed and the connection method in a case where the router 103 is not installed are described. In other words, the case where the router 103 is installed is an environment in which the wireless LAN or wired LAN can be used.

As the connection methods in the case where the router 103 is installed, a method using wireless communication, a method using wired communication and wireless communication, and a method using wired communication are described. As the method using wireless communication, for example, a method of wirelessly connecting the image forming apparatus 102 to the router 103 to perform communication is described. As the method using wired communication and wireless communication, for example, a method of connecting the information processing apparatus 101 and the router 103 via a wire and wirelessly connecting the image forming apparatus 102 to the router 103 is described. As the method using wired communication, a method of connecting the information processing apparatus 101 and the image forming apparatus 102 to the router 103 by a wired LAN cable, a USB cable, or the like. As the connection method in the case where the router 103 is not installed, a method of connecting the information processing apparatus 101 and the image forming apparatus 102 by a USB cable is described. As described above, when the Web manual is displayed, the user can confirm the method of connecting the information processing apparatus 101 and the image forming apparatus 102 in accordance with a use environment.

In the Web manual, for example, the operation method of the main body of the image forming apparatus 102 for wirelessly connecting the image forming apparatus 102 to the router 103, and the like may be described. As the operation method, for example, an operation of a physical button of the image forming apparatus 102 or a button on the touch panel of the display unit 259 may be described. For example, the image forming apparatus 102 detects the SSIDs of devices such as the router 103 around the image forming apparatus 102, and displays a list of the detected SSIDs of the devices on the panel of the display unit 259 or the like. As the operation method, for example, a method for performing setting to wirelessly connect the image forming apparatus 102 to the router 103 by selecting the SSID from the list of the SSIDs and inputting a password by the user may be possible. Some routers 103 may correspond to a Wi-Fi Protected Setup (to be referred to as WPS hereinafter) function defined by Wi-Fi Alliance. As the operation method, a method for connecting the image forming apparatus 102 and the router 103 using the WPS function and the like may be described. WPS is a function of executing a network setup using a push button or a PIN code, that is developed by Wi-Fi Alliance. Note that the operation method is not limited to the above-described method, and another method may be described.

In step S314, the application 214 accepts selection of the connection method from the user. More specifically, for example, the application 214 accepts selection of the connection method based on a user operation on the selection screen of the connection method of the image forming apparatus 102 displayed in step S311. That is, the application 214 accepts selection of one of the selection items 801 to 803.

In step S315, the application 214 executes a setup corresponding to the connection method decided in step S314 to perform connection to the image forming apparatus 102. That is, in accordance with the connection method decided in step S314, the application 214 confirms connection of the information processing apparatus 101 to the image forming apparatus 102. In other words, the application 214 performs communication confirmation between the information processing apparatus 101 and the image forming apparatus 102 by the connection method decided in step S314.

More specifically, for example, if the user selects the wired LAN connection as the connection method, the application 214 performs guidance for connection of the image forming apparatus 102 and the router 103 by the wired LAN. After the user connects the image forming apparatus 102 and the router 103 by the wired LAN, it is determined whether the information processing apparatus 101 can communicate with the printer via the router, similar to steps S303 and S307.

More specifically, for example, if the user selects the USB connection as the connection method, the application 214 performs guidance for USB connection between the image forming apparatus 102 and the information processing apparatus 101. After the user performs USB connection between the image forming apparatus 102 and the information processing apparatus 101, the application 214 performs communication confirmation using the SNMP via the USB. Note that the present invention is not limited to the communication confirmation using the SNMP and communication confirmation may be performed by another method.

More specifically, for example, if the user selects the wireless connection as the connection method, the application 214 re-executes step S301. Note that the present invention is not limited to a case where step S301 is re-executed. For example, an embodiment in which another setup such as the connection method using the WPS function is guided may be possible.

In the above description, after the network setup processing is executed in step S301, the conformation processing in step S302 and the subsequent processes are executed, but the present invention is not limited to this. The application 214 may execute the conformation processing in step S302 and the subsequent processes based on acceptance of a user instruction to establish communication between the image forming apparatus 102 and the information processing apparatus 101, which is different from a user instruction for the network setup processing.

FIG. 4A and FIG. 4B is a flowchart illustrating processing executed by the application 214 of this system. In this flowchart, the processing executed by the information processing apparatus 101 is implemented by reading out various programs stored in the memory such as the ROM 204 to the RAM 205 and executing them by the CPU 203. For example, the application 214 executes the processing shown in FIG. 4A and FIG. 4B as the processing in step S301 of FIG. 3A. That is, FIG. 4A and FIG. 4B is a flowchart illustrating the network setup processing executed by the application 214.

In step S401, the application 214 performs guidance for setting of the image forming apparatus 102 in the network setup mode. More specifically, for example, the application 214 may make a notification of a guidance for setting the image forming apparatus 102 in the network setup mode. For example, the application 214 may display, on the display unit 208, the guidance for setting the image forming apparatus 102 in the network setup mode. Alternatively, for example, the application 214 may transmit, to the image forming apparatus 102, a specific signal for setting the image forming apparatus 102 in the network setup mode.

Note that as described above, when the image forming apparatus 102 is set in the network setup mode, the image forming apparatus 102 can establish Wi-Fi direct connection to the information processing apparatus 101. That is, the image forming apparatus 102 can transmit the identification information and password of the image forming apparatus 102 to the information processing apparatus 101. The identification information of the image forming apparatus 102 is the SSID set by the provider of the image forming apparatus 102, or the like, and includes, for example, information of the maker name, serial number, and model name.

In step S402, the application 214 determines whether the SSID of the image forming apparatus 102 is detected. If the application 214 determines that the SSID is detected, the process advances to step S403. On the other hand, if the application 214 determines that the SSID is not detected, the process advances to step S416. More specifically, for example, the application 214 searches for surrounding routers using the wireless interface 211. The application 214 determines whether the image forming apparatus 102 in the network setup mode set in step S301 is detected.

Note that if the application 214 detects the image forming apparatus 102 in step S402, the application 214 may determine whether the image forming apparatus 102 is a support target model before advancing to step S403. The support target model is a model supported by the application 214, and is, in other words, a model corresponding to the application 214. The model supported by the application 214 is, for example, the image forming apparatus 102 provided by the same vendor as the vendor that provides the application 214. If the application 214 determines that the image forming apparatus 102 is the supported model, the process may advance to step S403. If the application 214 determines that that the image forming apparatus 102 is not the supported model, the process may advance to step S416. More specifically, with reference to information held in advance in the application 214, the application 214 may determine whether the detected SSID is the support target model.

In step S403, the application 214 acquires the identification information of the router 103 to which the information processing apparatus 101 is connected. The application 214 may instruct the OS of the information processing apparatus 101 to acquire the SSID of the router 103.

In step S404, the application 214 determines whether it is possible to acquire authentication information of the router 103 to which the information processing apparatus 101 is currently connected. More specifically, the authentication information of the router 103 is a password for connection to an access point enabled by the router 103. Note that in this embodiment, the router 103 enables both an access point that forms a network connectable using the 2.4-GHz band and an access point that forms a network connectable using the 5-GHz band, and both the access points can be connected by the same password. If the application 214 determines that the authentication information can be acquired, the process advances to step S407. On the other hand, if the application 214 determines that the authentication information cannot be acquired, the process advances to step S405. Note that if the setting of the router 103 is such setting that the router 103 is connectable without a password, the process may advance to step S407 by skipping this processing.

More specifically, for example, in step S404, the application 214 determines whether it is possible to acquire a password from a Wi-Fi profile stored in the information processing apparatus 101. For example, if the information processing apparatus 101 is a predetermined OS (for example, Windows®), an SSID and an encrypted password may be stored as a Wi-Fi profile in the ROM 204 of the information processing apparatus 101. In this case, the application 214 can acquire the password of the router 103 by decrypting the encrypted password with reference to the Wi-Fi profile that matches the SSID acquired in step S403. Note that the application 214 may instruct the OS of the information processing apparatus 101 to execute these processes. A case where it is impossible to acquire, in step S404, the authentication information of the router 103 to which the information processing apparatus 101 is currently connected is, for example, a case where the above acquisition of the Wi-Fi profile is restricted by security of the OS of the information processing apparatus 101 or the like. In step S404, if the security method of the router 103 currently connected to the information processing apparatus 101 is a method that does not need authentication information such as a password, the application 214 advances to step S407.

In step S405, the application 214 displays, on the display unit 208, a password input screen (not shown) of the router 103 currently connected to the information processing apparatus 101. The password input screen is an interface that can accept input of a password. As described above, for example, even if it is impossible to acquire the password of the router 103 from the Wi-Fi profile due to security of the OS of the information processing apparatus 101 or the like, it is possible to acquire the password of the router 103 by accepting input of the password.

In step S406, the application 214 determines whether it is possible to perform connection to the router 103 using the password, the input of which has been accepted in step S405. If the application 214 determines that it is possible to perform connection, the process advances to step S407. On the other hand, if the application 214 determines that it is impossible to perform connection, the process advances to step S416. More specifically, for example, the application 214 disconnects from the connected router 103. After that, the application 214 attempts to perform connection to the router 103 again using the password, the input of which has been accepted in step S405. For example, if the password, the input of which has been accepted in step S405, is an incorrect password, NO is determined in step S406.

In step S407, the application 214 starts wireless connection to the image forming apparatus 102. For example, the application 214 attempts to wirelessly connect the information processing apparatus 101 to the image forming apparatus 102 by communication using the above-described direct connection. More specifically, for example, the application 214 disconnects from the router 103, and attempts to perform wireless connection to the image forming apparatus 102. Note that when performing wireless connection to the image forming apparatus 102 in the network setup mode, it may be possible to perform connection without the password. Alternatively, the application 214 may know in advance a password set by the provider of the image forming apparatus 102. The direct connection may be established not by Wi-Fi but by another communication standard such as Bluetooth Classic or Bluetooth Low Energy. Then, in a form in which direct connection is established by another communication standard, configuration may be such that the connection to the router 103 is not disconnected and is maintained.

In step S408, the application 214 determines whether wireless connection to the image forming apparatus 102 succeeds. If the application 214 determines that wireless connection succeeds, the process advances to step S409. On the other hand, if the application 214 determines that wireless connection fails, the process advances to step S416.

In step S409, the application 214 acquires information of the wireless frequency band corresponding to the image forming apparatus 102. For example, the application 214 acquires, from the image forming apparatus 102, the information of the wireless frequency band corresponding to the image forming apparatus 102 by requesting the information from the image forming apparatus 102. Note that the request of the information of the wireless frequency band may be sent using wireless communication by the above-described direct connection to the image forming apparatus 102. More specifically, for example, the application 214 transmits an SNMP Get Request command, thereby acquiring, from the image forming apparatus 102, the information of the frequency band corresponding to the image forming apparatus 102. In step S409, the application 214 stores the acquired information of the frequency band corresponding to the image forming apparatus 102 in the memory such as the external storage device 206 or the ROM 204. The application 214 may instruct the OS of the information processing apparatus 101 to execute processing of acquiring and storing the information of the frequency band corresponding to the image forming apparatus 102.

In step S410, the application 214 determines whether the frequency band in which the information processing apparatus 101 is wirelessly connected is the same as the frequency band corresponding to the printer. In other words, the application 214 determines whether the frequency band used by the wireless interface 211 of the information processing apparatus 101 is the same as the frequency band corresponding to the printer. If the application 214 determines that the frequency bands are the same, the process advances to step S414. On the other hand, if the application 214 determines that the frequency bands are different, the process advances to step S411.

In step S411, the application 214 acquires the SSIDs and information of the frequency band of the routers detected by the image forming apparatus 102. For example, the application 214 requests, of the image forming apparatus 102, the SSIDs of the routers detected by the image forming apparatus 102 and the information of the frequency band. By receiving a response of the image forming apparatus 102 to the request, the SSIDs of the routers and the information of the frequency band are acquired. More specifically, the application 214 is connected to the image forming apparatus 102 by communication using the direct connection, as described above, and transmits an SNMP Get Request command from the information processing apparatus 101, thereby acquiring a list of the SSIDs of the routers detected by the image forming apparatus 102 and the information of the frequency band. Note that the application 214 may instruct the OS of the information processing apparatus 101 to execute these processes.

In step S412, the application 214 displays a screen for accepting selection of the SSID of the router detected by the image forming apparatus 102 and input of a password. The application 214 lists the SSIDs of the routers acquired from the image forming apparatus 102 in step S411, and displays them on the display unit 208 of the information processing apparatus 101, thereby accepting selection of the SSID to be set from the user. In addition, the application 214 accepts input of a password corresponding to the SSID selected within the same screen.

In step S413, the application 214 determines whether the information processing apparatus 101 can be wirelessly connected to the router using the SSID and password input in step S411. If the application 214 determines that wireless connection is possible, the process advances to step S414. On the other hand, if the application 214 determines that wireless connection is impossible, the process advances to step S416. For example, in step S413, the application 214 confirms the integrity of the password input in step S412. More specifically, for example, the application 214 disconnects the connection from the image forming apparatus 102. The application 214 executes communication confirmation by attempting to temporarily perform wireless connection between the information processing apparatus 101 and the router 103 using the password input in step S413. If wireless connection between the information processing apparatus 101 and the router 103 is confirmed, the application 214 determines that wireless connection is possible. On the other hand, if wireless connection between the information processing apparatus 101 and the router 103 is not confirmed, the application 214 determines that wireless connection is impossible. After confirming wireless connection between the information processing apparatus 101 and the router 103, the application 214 executes wireless connection between the information processing apparatus 101 and the image forming apparatus 102. The application 214 may instruct the OS of the information processing apparatus 101 to execute the processing in step S413.

In step S414, the application 214 transmits the connection information of the router 103 to the image forming apparatus 102. More specifically, for example, the information processing apparatus 101 and the image forming apparatus 102 are connected by communication using the direct connection, as described above. The application 214 transmits the SSID of the router 103 and the information of the frequency band acquired in step S412, and the connection information such as a password to the image forming apparatus 102 by an SNMP Set Request command. When the information processing apparatus 101 transmits the connection information of the router 103, as described above, the image forming apparatus 102 can detect the SSID of the router 103, and can be wirelessly connected to the router 103 using the information such as a password. The application 214 may instruct the OS of the information processing apparatus 101 to transmit the connection information of the router 103 to the image forming apparatus 102.

In step S415, the application 214 starts wireless connection between the information processing apparatus 101 and the router 103. More specifically, for example, the application 214 disconnects the wireless connection between the information processing apparatus 101 and the image forming apparatus 102. After that, the application 214 executes wireless connection between the information processing apparatus 101 and the router 103 using the SSID of the router 103, the information of the frequency band, and the connection information such as a password. Note that the application 214 may instruct the OS of the information processing apparatus 101 to start wireless connection between the information processing apparatus 101 and the router 103.

Note that if the frequency band used by the wireless interface 211 of the information processing apparatus 101 is different from the frequency band supported by the image forming apparatus 102 (NO in step S410), the frequency band used by the image forming apparatus 102 may be different from the frequency band used by the information processing apparatus 101. That is, the frequency band used by the image forming apparatus 102 for wireless connection to the router 103 may be different from the frequency band used by the information processing apparatus 101 for wireless connection to the router 103.

In step S416, the application 214 executes display of a Web manual for setting of a wireless connection between the information processing apparatus 101 and the router 103. Note that step S416 may be, for example, the same processing as that in step S313. That is, the Web manual displayed in step S416 is the same as that described above with reference to FIG. 8. For example, the application 214 may instruct the OS of the information processing apparatus 101 to display the Web manual.

Note that this embodiment has explained the form in which the application 214 displays the Web manual in step S416 but the present invention is not limited to this. For example, this embodiment assumes a state in which the information processing apparatus 101 and the router 103 are wirelessly connected in step S416. In step S416, in a state in which the information processing apparatus 101 is not connected to the router 103, the application 214 may perform the same processes as those in steps S411 and S412 described above. That is, the application 214 acquires a list of the SSIDs of the routers detected by the image forming apparatus 102, and displays it on the display unit 208 of the information processing apparatus 101. When the user selects the SSID from the list of the SSIDs, the application 214 displays a screen for accepting input of a password corresponding to the SSID. The application 214 may acquire information of the password of the router 103 in this way.

FIG. 5 is a flowchart illustrating processing executed by the application 214 of this system. In this flowchart, the processing executed by the application 214 is implemented by, for example, deploying a control program stored in the memory such as the ROM 204 into the RAM 205 and executing it by the CPU 203. For example, the application 214 executes the processing shown in FIG. 5 as the processing in step S304 of FIG. 3A. That is, FIG. 5 is a flowchart illustrating the setting change processing of the wireless interface 211 of the information processing apparatus 101 executed by the application 214.

In step S501, the application 214 confirms the frequency band usable by the wireless interface 211 of the information processing apparatus 101. For example, the application 214 may instruct the OS of the information processing apparatus 101 to acquire information of the frequency band usable by the wireless interface 211 of the information processing apparatus 101.

In step S502, the application 214 determines whether the number of frequency bands usable by the wireless interface 211 of the information processing apparatus 101 is two or more. In other words, the application 214 determines whether the wireless interface 211 of the information processing apparatus 101 corresponds to a plurality of frequency bands. That is, the application 214 determines whether the wireless interface 211 of the information processing apparatus 101 can use the plurality of frequency bands. If the application 214 determines that the number of usable frequency bands is two or more, the process advances to step S503. On the other hand, if the application 214 determines that the number of usable frequency bands is smaller than two, the process advances to step S510. More specifically, for example, the application 214 performs the determination processing in step S502 based on the information of the frequency band usable by the wireless interface 211 of the information processing apparatus 101, which has been acquired in step S501. For example, in step S502, it is determined whether the wireless interface 211 can use different frequency bands such as the 2.4-GHz band and 5-GHz band.

In step S503, the application 214 determines whether it is possible to acquire the password of the connected router 103. If the application 214 determines that it is possible to acquire the password, the process advances to step S504. On the other hand, if the application 214 determines that it is impossible to acquire the password, the process advances to step S510. Note that the determination processing in step S503 is the same as the processing in step S404 and a description thereof will be omitted.

In step S504, the application 214 acquires the SSID and password of the connected router 103. More specifically, for example, the application 214 decrypts and acquires the SSID and encrypted password of the router 103 stored as a Wi-Fi profile in the information processing apparatus 101. The application 214 may instruct the OS of the information processing apparatus 101 to acquire the SSID and password of the connected router 103.

In step S505, the application 214 acquires information of the frequency band used by the wireless interface 211 of the information processing apparatus 101. Furthermore, the application 214 may instruct the OS of the information processing apparatus 101 to acquire the information of the frequency band currently used by the information processing apparatus 101.

In step S506, the application 214 changes the priority frequency band of the wireless interface 211 of the information processing apparatus 101. More specifically, for example, the application 214 changes the setting to match the same frequency band as that corresponding to the image forming apparatus 102 with reference to the information of the frequency band corresponding to the image forming apparatus 102, which has been acquired in step S409.

As described above, in step S506, the application 214 changes setting contents in a setting item, concerning Wi-Fi Agile Multiband performed for the OS, of the frequency band (priority frequency band) preferentially used by the wireless interface 211. More specifically, the application 214 changes the setting contents in the setting item to the frequency band corresponding to the image forming apparatus 102. Note that the priority frequency band is a frequency band preferentially used in wireless connection to the router supporting the Wi-Fi Agile Multiband function, which is established by the wireless interface 211. If the priority frequency band is set in the information processing apparatus 101, the information processing apparatus 101 that is wirelessly connected to the router supporting the Wi-Fi Agile Multiband function executes predetermined control not to switch to connection using a frequency band other than the priority frequency band in accordance with the Wi-Fi Agile Multiband function.

More specifically, for example, the predetermined control is such control that even if a connection destination switching request to request switching of the connection destination to a network that uses a frequency band other than the priority frequency band is received from the router, an operation is performed not to comply with the request. That is, more specifically, for example, the predetermined control is such control that when a connection destination switching request to request switching of the connection destination to a network that uses a frequency band other than the priority frequency band is received from the router, a response representing rejection of switching of the connection destination is transmitted to the router. In this form, even if the information processing apparatus 101 receives the switching request, it maintains the priority frequency band without changing the frequency band used in connection to the router 103 to the frequency band corresponding to the request.

Note that the predetermined condition is not limited to the above-described form. For example, the predetermined control may be such control that even if a measurement request is received from the router in a state in which connection to the router is established using the priority frequency band, measurement based on the measurement request is not executed and a response to the measurement request is not transmitted. For example, the predetermined control may be such control that a response to the measurement request is transmitted but the response to the measurement request includes not information concerning the network that uses the frequency band other than the priority frequency band but information concerning the network that uses the priority frequency band.

For example, the predetermined control may be such control that the router does not send a connection destination switching request to request switching of the connection destination to the network that uses the frequency band other than the priority frequency band. More specifically, the predetermined control is such control that information including the number of each channel corresponding to a frequency band other than the priority frequency band in a non-preferred channel designation field in a BSS Transition Management (BTM) Request frame defined by the IEEE 802.11v standard is transmitted to the router. Each channel indicated by the transmitted information is a non-preferred channel, and control is executed so the router that has accepted a notification of the non-preferred channel does not specify, as a change target network, the network that uses the non-preferred channel. For example, the above information is transmitted by the information processing apparatus 101 when the information processing apparatus 101 and the router are connected. Thus, even if, for example, the router 103 is restricted in terms of communication in different frequency bands, the information processing apparatus 101 can communicate with the image forming apparatus 102 via the router 103.

In step S507, the application 214 instructs the OS to start wireless connection to the router 103 using the connection information of the router 103 acquired in step S504. An attempt to establish wireless connection to the router 103, which is executed by the OS based on the instruction, is executed based on the setting concerning Wi-Fi Agile Multiband performed in step S506. That is, the OS first attempts to establish wireless connection to the router 103 using the priority frequency band. If this attempt fails, the OS attempts to establish wireless connection to the router 103 using a frequency band different from the priority frequency band. That is, the OS attempts to establish wireless connection to the router 103 by preferentially using the priority frequency band. The connection information of the router 103 includes the SSID and password. When the application 214 changes the priority frequency band of the wireless interface 211 of the information processing apparatus 101 in step S506, the wireless connection to the router 103 to which the information processing apparatus 101 is connected is disconnected. Therefore, processing of reconnecting the information processing apparatus 101 to the router 103 is performed in step S507.

If establishment of wireless connection to the router 103 using the priority frequency band succeeds, the OS of the information processing apparatus 101 appropriately executes the above-described predetermined control based on the setting concerning Wi-Fi Agile Multiband performed in step S506. Note that if establishment of wireless connection to the router 103 using the priority frequency band fails and establishment of wireless connection to the router 103 using a frequency band different from the priority frequency band succeeds, the OS of the information processing apparatus 101 may execute the Wi-Fi Agile Multiband function in accordance with the request received from the router 103. That is, if establishment of wireless connection to the router 103 using a frequency band different from the priority frequency band succeeds, the OS of the information processing apparatus 101 may execute connection destination switching based on the connection destination switching request received from the router 103. However, if, as a result of the connection destination switching, wireless connection to the router 103 using the priority frequency band is established, the OS of the information processing apparatus 101 appropriately executes the above-described predetermined control based on the setting concerning Wi-Fi Agile Multiband performed in step S506.

In step S508, the application 214 determines whether the information processing apparatus 101 and the router 103 can be wirelessly connected using the SSID and password of the router 103 acquired in step S504. If the application 214 determines that these apparatuses can be wirelessly connected, the process advances to step S510. On the other hand, if the application 214 determines that these apparatuses cannot be wirelessly connected, the process advances to step S509.

If, for example, the Wi-Fi Agile Multiband function of the router 103 is enabled, the same password of the router 103 is set for different frequency bands. In this case, even if the frequency band used by the wireless interface 211 of the information processing apparatus 101 is changed in step S506, it is possible to perform wireless connection to the router 103 using the same password. More specifically, for example, assume a case where the information processing apparatus 101 is connected to the router 103 in the 5-GHz frequency band. In this case, even if the frequency band used by the information processing apparatus 101 is changed from the 5-GHz band to the 2.4-GHz band, the password used in connection in the 5-GHz band can also be used in connection in the 2.4-GHz band.

If, for example, the Wi-Fi Agile Multiband function of the router 103 is not enabled, different passwords may be set in the router 103 for different frequency bands. Therefore, since the change of the frequency band used by the wireless interface 211 of the information processing apparatus 101 in the processing in step S506 may cause wireless connection between the information processing apparatus 101 and the router 103 to fail, the process advances to step S509.

In step S509, the application 214 returns the priority frequency band of the wireless interface 211 of the information processing apparatus 101 to the original setting. That is, the application 214 changes the frequency band used by the wireless interface 211 of the information processing apparatus 101 to the frequency band originally used. The application 214 may instruct the OS of the information processing apparatus 101 to change the priority frequency band of the wireless interface 211.

Note that this embodiment has explained the form in which if NO is determined in step S508, the application 214 returns the priority frequency band of the wireless interface 211 to the original setting in step S509 but the present invention is not limited to this. For example, if NO is determined in step S508, the application 214 may display a password input screen, and accept input of a password. After that, the application 214 may execute the same processes as those in steps S507 and S508 using the password, the input of which has been accepted. As described above, different passwords may be set in the router 103 for different frequency bands. In this case as well, if NO is determined in step S508, the password may be acquired in accordance with the change (step S506) of the frequency band used by the wireless interface 211 of the information processing apparatus 101, and connection confirmation between the information processing apparatus 101 and the router 103 may be executed.

Furthermore, this embodiment has exemplified a case where the information processing apparatus 101 can use two frequency bands of the 2.4-GHz band and the 5-GHz band but the present invention is not limited to this. For example, the information processing apparatus 101 may correspond to three or more frequency bands. In this case, for example, the processes in steps S506 to S509 may be repeated the number of times which is equal to the number of frequency bands usable by the information processing apparatus 101.

In step S510, the application 214 acquires information of the frequency band used by the wireless interface 211 of the information processing apparatus 101. The application 214 may instruct the OS of the information processing apparatus 101 to acquire the information of the frequency band used by the wireless interface 211 of the information processing apparatus 101. This can determine whether the information processing apparatus 101 is connected to the router 103 in the priority frequency band in step S305 of FIG. 3B.

According to this embodiment described above, the computer of the information processing apparatus 101 is caused to execute communication confirmation (step S302) to confirm the communication state with an external apparatus such as the image forming apparatus 102 via the router 103. If, by the communication confirmation, it is confirmed that the communication state with the external apparatus via the router 103 is a communication disable state (NO in step S303), the frequency band used by the wireless interface 211 of the information processing apparatus 101 is changed (step S304). Based on the fact that the frequency band used by the wireless interface 211 of the information processing apparatus 101 is changed, the communication state with the external apparatus via the router 103 is confirmed (step S306). In this form, it is possible to improve convenience in a case where it is impossible to execute communication with the image forming apparatus 102 via the router 103.

According to this embodiment, after the network setup processing (step S301), the information processing apparatus 101 confirms the communication state with the image forming apparatus 102 via the router 103 (step S302). In this form, by the network setup processing, it is possible to confirm whether connection of the image forming apparatus 102 to the router 103 succeeds.

According to this embodiment, the priority frequency band of the wireless interface 211 of the information processing apparatus 101 is changed to the same frequency band as the frequency band corresponding to the image forming apparatus 102 (step S304). Thus, even if, for example, the router 103 is restricted in terms of communication in a plurality of frequency bands, the information processing apparatus 101 can communicate with the image forming apparatus 102 via the router 103.

According to this embodiment, the setting of the frequency band used by the wireless interface 211 of the information processing apparatus 101 is changed to the priority frequency band (step S304). Thus, even if the information processing apparatus 101 is reactivated, the frequency band used by the wireless interface 211 of the information processing apparatus 101 is the set priority frequency band.

According to this embodiment, if, after changing the frequency band used by the wireless interface 211 of the information processing apparatus 101, the information processing apparatus 101 cannot communicate with the printer via the router 103 (NO in step S307), the selection screen of the connection method is displayed (step S311). Thus, even if the information processing apparatus 101 cannot communicate with the printer via the router 103, another connection method can be selected.

This embodiment has explained the form in which step S301 is executed in the processing shown in FIG. 3A but the present invention is not limited to this. For example, the application 214 may perform step S301 at the time of initial activation, and may skip step S301 when the application 214 is reactivated after that. That is, at the time of arrival of the image forming apparatus 102 or the like, the network setup processing for connecting the image forming apparatus 102 to the router 103 may be performed. After that, when the application 214 is activated to use the function of the image forming apparatus 102 from the information processing apparatus 101, the processing in step S301 may be skipped. As described above, when the application 214 is activated to use the function of the image forming apparatus 102 from the information processing apparatus 101, communication confirmation with the image forming apparatus 102 via the router 103 is executed. When the setting change processing (step S304) of the wireless interface 211 of the information processing apparatus 101 is executed in accordance with the confirmation result, it is possible to improve convenience.

This embodiment has explained the example in which the application 214 changes the frequency band used by the information processing apparatus 101 to the frequency band corresponding to the image forming apparatus 102 in the processing in step S506 of FIG. 5 but the present invention is not limited to this. In step S506, for example, the application 214 may change the frequency band used by the wireless interface 211 of the information processing apparatus 101 from the frequency band currently used by the wireless interface 211 to another frequency band. More specifically, for example, the application 214 acquires information of the frequency band usable by the wireless interface 211 in step S501, and acquires information of the frequency band usable by the wireless interface 211 in step S505. In step S506, based on these pieces of information, the application 214 may change the frequency band used by the wireless interface 211 from the frequency band currently used by the wireless interface 211 to the frequency band usable by the wireless interface 211.

More specifically, for example, if the information processing apparatus 101 uses the 5-GHz frequency band for wireless connection to the router 103, as described above, the priority frequency band of the wireless interface 211 is changed to the 2.4-GHz band usable by the wireless interface 211. Thus, for example, even if an obstacle or the like exists between the information processing apparatus 101 and the router 103 and connection between the information processing apparatus 101 and the router 103 is unstable, the information processing apparatus 101 can communicate with the image forming apparatus 102 via the router 103.

More specifically, for example, if the information processing apparatus 101 uses the 2.4-GHz frequency band for wireless connection to the router 103, the priority frequency band of the wireless interface 211 is changed to the 5-GHz band usable by the wireless interface 211. Thus, for example, even in a status in which an electronic device that operates in the 2.4-GHz band like a microwave oven exists around the information processing apparatus 101, and interferes with wireless connection between the information processing apparatus 101 and the router 103, the information processing apparatus 101 can communicate with the image forming apparatus 102 via the router 103.

### Second Embodiment

The second embodiment will be described below concerning points different from the first embodiment. The first embodiment has explained the form in which in the setting change processing of the wireless interface 211 of the information processing apparatus 101 in step S304, processing of confirming the frequency band usable by the wireless interface 211 is executed first. This embodiment will describe a form in which setting information of a router 103 is acquired first in processing in step S304. This prevents processing of changing the priority frequency band of a wireless interface 211 from being unnecessarily executed. Furthermore, it is possible to prevent a failure when performing reconnection to the router 103 along with the change of the frequency band.

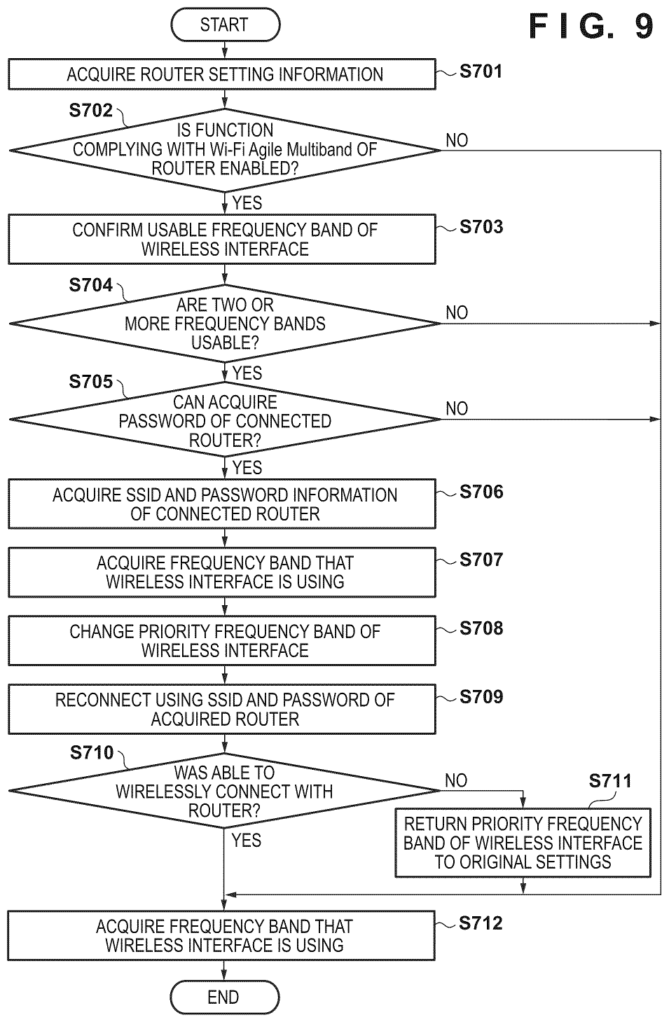

FIG. 9 is a flowchart illustrating processing executed by an application 214 of this system. In this flowchart, the processing executed by the application 214 is implemented by, for example, deploying a control program stored in a memory such as a ROM 204 into a RAM 205 and executing it by a CPU 203. For example, the application 214 executes the processing shown in FIG. 9 as processing in step S304 of FIG. 3A. That is, FIG. 9 is a flowchart illustrating the setting change processing of the wireless interface 211 of an information processing apparatus 101 executed by the application 214.

In step S701, the application 214 acquires setting information of the router 103. The setting information is, for example, information representing whether the Wi-Fi Agile Multiband function of the router 103 is enabled. The setting information includes, for example, the SSID of the router 103, information indicating an encryption method, and information indicating the version of a Virtual Private Network (VPN). More specifically, for example, the application 214 acquires the setting information of the router 103 using an Application Programming Interface (API). The API may be provided from the provider of the router 103. For example, if the API for acquiring the enabled state of the Wi-Fi Agile Multiband function is provided, the application 214 calls the API to transmit a request command from the information processing apparatus 101 to the router 103. The router 103 transmits response information to the information processing apparatus 101 in accordance with contents of the request received from the information processing apparatus 101.

In step S702, the application 214 determines whether a setting concerning Wi-Fi Agile Multiband of the router 103 is enabled. If the application 214 determines that the Wi-Fi Agile Multiband function of the router 103 is enabled, the process advances to step S703. On the other hand, if the application 214 determines that the Wi-Fi Agile Multiband function of the router 103 is not enabled (disabled), the process advances to step S712. More specifically, for example, the application 214 can determine whether the enabled state of the Wi-Fi Agile Multiband function is True or False, by receiving the above-described response information from the router 103 by the information processing apparatus 101.

Note that the processes in steps S703 to S712 are the same as those in steps S501 to S510 of FIG. 5 and a description thereof will be omitted.

As described above, according to this embodiment, the application 214 acquires the setting information of the router 103 in the setting change processing of the wireless interface 211 (step S701). Based on the setting information of the router 103, the application 214 determines whether the Wi-Fi Agile Multiband function of the router 103 is enabled (step S702). For example, if the Wi-Fi Agile Multiband function of the router 103 is enabled, the router 103 can communicate in a plurality of frequency bands, and the same password can be set for the plurality of frequency bands. Therefore, if it is determined that the Wi-Fi Agile Multiband function of the router 103 is enabled, the application 214 changes the priority frequency band of the wireless interface 211. For example, if the Wi-Fi Agile Multiband function of the router 103 is disabled, the router 103 cannot sometimes communicate in the plurality of frequency bands. Therefore, on the other hand, if it is determined that Wi-Fi Agile Multiband function of the router 103 is disabled, the application 214 does not change the priority frequency band of the wireless interface 211. This form prevents the processing of changing the priority frequency band of the wireless interface 211 from being unnecessarily executed. In addition, it is possible to prevent a failure when performing reconnection to the router 103 along with the change of the frequency band.

Note that various control operations described above that are performed by the CPU 203 may be performed by one hardware component, or control of the overall apparatus may be performed by sharing processing between a plurality of hardware components (for example, a plurality of processors or circuits).

The present invention is not limited to the above embodiments and various changes and modifications can be made within the spirit and scope of the present invention. Therefore, to apprise the public of the scope of the present invention, the following claims are made.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-197591, filed Nov. 21, 2023 which is hereby incorporated by reference herein in its entirety.

What is claimed is:

1. A non-transitory computer-readable storage medium storing a program configured to cause a computer to function as:
a confirmation unit configured to confirm a communication state between an information processing apparatus and an external apparatus via a predetermined relay apparatus; and
a control unit configured to execute control based on a fact that the confirmed communication state is a predetermined state so that a frequency band used in connection between the information processing apparatus and the predetermined relay apparatus is changed from a first frequency band to a second frequency band different from the first frequency band.

2. The medium according to claim 1, wherein the program further causes the computer to function as a reconfirmation unit configured to reconfirm the communication state after the frequency band used in the connection between the information processing apparatus and the predetermined relay apparatus is changed from the first frequency band to the second frequency band.

3. The medium according to claim 1, wherein
the program further causes the computer to function as a transmission unit configured to transmit, to the external apparatus, information for connection to the predetermined relay apparatus,
in a case where the information for connection to the predetermined relay apparatus is received, the external apparatus is connected to the predetermined relay apparatus based on the information for connection to the predetermined relay apparatus, and
after the information for connection to the predetermined relay apparatus is transmitted, the communication state is confirmed.

4. The medium according to claim 3, wherein the information for connection to the predetermined relay apparatus is transmitted via connection between the information processing apparatus and the external apparatus without intervention of the predetermined relay apparatus.

5. The medium according to claim 4, wherein the connection between the information processing apparatus and the external apparatus without intervention of the predetermined relay apparatus is Wi-Fi connection.

6. The medium according to claim 4, wherein the connection between the information processing apparatus and the external apparatus without intervention of the predetermined relay apparatus is one of Bluetooth Classic connection and Bluetooth Low Energy connection.

7. The medium according to claim 4, wherein the predetermined relay apparatus is an apparatus to which the information processing apparatus was connected before establishment of the connection between the information processing apparatus and the external apparatus without intervention of the predetermined relay apparatus.

8. The medium according to claim 3, wherein the program further causes the computer to function as an establishment unit configured to establish connection between the information processing apparatus and the predetermined relay apparatus after the information for connection to the predetermined relay apparatus is transmitted to the external apparatus.

9. The medium according to claim 8, wherein the communication state is confirmed after the information for connection to the predetermined relay apparatus is transmitted to the external apparatus and after the connection between the information processing apparatus and the predetermined relay apparatus is established.

10. The medium according to claim 1, wherein the processing of executing control to change the frequency band used in the connection between the information processing apparatus and the predetermined relay apparatus from the first frequency band to the second frequency band includes processing of disconnecting the connection between the information processing apparatus and the predetermined relay apparatus using the first frequency band, and processing of establishing the connection between information processing apparatus and the predetermined relay apparatus using the second frequency band.

11. The medium according to claim 10, wherein for the connection between information processing apparatus and the predetermined relay apparatus using the second frequency band, a password that is the same as a password for the connection between information processing apparatus and the predetermined relay apparatus using the first frequency band is used.

12. The medium according to claim 1, wherein the program further causes the computer to function as a second control unit configured to execute control based on the fact that the confirmed communication state is the predetermined state so the frequency band used in the connection between the information processing apparatus and the predetermined relay apparatus is not changed from the second frequency band to the first frequency band in accordance with a Wi-Fi Agile Multiband function.

13. The medium according to claim 12, wherein the processing of executing control not to change the frequency band used in the connection between the information processing apparatus and the predetermined relay apparatus from the second frequency band to the first frequency band in accordance with the Wi-Fi Agile Multiband function includes processing of executing control not to change the frequency band used in the connection between the information processing apparatus and the predetermined relay apparatus from the second frequency band to the first frequency band even if the information processing apparatus receives, from the predetermined relay apparatus, a predetermined request that is a request based on the Wi-Fi Agile Multiband function and a request corresponding to the first frequency band.

14. The medium according to claim 12, wherein the processing of executing control not to change the frequency band used in the connection between the information processing apparatus and the predetermined relay apparatus from the second frequency band to the first frequency band in accordance with the Wi-Fi Agile Multiband function includes processing of executing control not to receive, from the predetermined relay apparatus, a predetermined request that is a request based on the Wi-Fi Agile Multiband function and a request corresponding to the first frequency band.

15. The medium according to claim 1, wherein the predetermined state is at least one of a state in which communication between the information processing apparatus and the external apparatus via the predetermined relay apparatus is impossible and a state in which communication quality of communication between the information processing apparatus and the external apparatus via the predetermined relay apparatus is not higher than a predetermined threshold.

16. The medium according to claim 1, wherein each of the first frequency band and the second frequency band is at least one of a 2.4-GHz band and a 5-GHz band.

17. The medium according to claim 1, wherein the external apparatus is a printing apparatus.

18. The medium according to claim 1, wherein the case where the confirmed communication state is the predetermined state is a case where the frequency band used in the connection between the predetermined relay apparatus and the information processing apparatus is different from a frequency band used in connection between the predetermined relay apparatus and the external apparatus.

19. An information processing apparatus comprising at least one memory and at least one processor which function as:
a confirmation unit configured to confirm a communication state between the information processing apparatus and an external apparatus via a predetermined relay apparatus; and
a control unit configured to execute control based on a fact that the confirmed communication state is a predetermined state so that a frequency band used in connection between the information processing apparatus and the predetermined relay apparatus is changed from a first frequency band to a second frequency band different from the first frequency band.

20. A control method of an information processing apparatus, comprising:
confirming a communication state between the information processing apparatus and an external apparatus via a predetermined relay apparatus; and
executing control based on a fact that the confirmed communication state is a predetermined state so that a frequency band used in connection between the information processing apparatus and the predetermined relay apparatus is changed from a first frequency band to a second frequency band different from the first frequency band.
